(19) United States
(12) Patent Application Publication
(10) Pub. No.: US 2005/0198251 A1
(43) Pub. Date: Sep. 8, 2005

(54) Network management system

(76) Inventor: Junichi Toda, Kawasaki (JP)

Correspondence Address: KATTEN MUCHIN ROSENMAN LLP, 575 MADISON AVENUE, NEW YORK, NY, 10022-2585, US

(21) Appl. No.: 11/098,730

(22) Filed: Apr. 4, 2005

Related U.S. Application Data
(63) Continuation of application No. PCT/JP02/12933, filed on Dec. 10, 2002.

(51) Int. Cl. G06F 15/16

(52) U.S. Cl. 709/223; 709/249

(57) ABSTRACT

A network management system includes: a management unit managing trail configuration information, trail name information, and work-related information related to trail management work as trail-related information related to trails that compose an integration network that is formed by integrating a plurality of networks belonging to different categories, and is provided with at least one network management apparatus in each category; and a calling unit calling a operation screen of the management apparatus that serves to execute the trail management work managed in a management apparatus side based on the trail-related information.

### BACKGROUND OF THE INVENTION

The present invention relates to a network management system, and more particularly to a technique of managing an integration network obtained by integrating a plurality of networks each belonging to one of different categories.

In recent years, networks belonging to various communication service categories are integrated (inter-connected) into an integration network. Wide-ranging examples of the communication service categories include an IP (Internet Protocol), an ATM (Asynchronous Transfer Mode), and a backbone, and their combinations vary widely.

As an attempt to manage the integration network unitarily, hierarchical network management systems based on the TMN (Telecommunications Management Network) recommendations are suggested. The TMN represents a network for managing communications, and the TMN recommendations are a regulation standardized by the ITU-T to manage an environment in which a plurality of networks are inter-connected.

Each of networks as an integration target includes a plurality of network elements (NEs) as transmission apparatuses for transmitting user data and a network element-operation system (NE-OPS) as an apparatus for managing and controlling the NEs. The NE-OPS is also called a Network Managing System (NMS).

In recent years, the NEs and NE-OPSs are introduced per category on multi-vendor environments. The NEs have different functions (multiplexing method, exchanging method, etc.) depending on the categories. Also, An NE-OPS corresponding to functions of an NE is provided. Accordingly, the current integration network is divided and operated per category.

Therefore, in the case of operating (managing, monitoring, controlling, etc.) the integration network, an operator of the integration network must be sensitive to connection relationships between categories in order to grasp the overall operation of the integration network. In view of this, to operate the integration network, the operator prepares materials for managing the connection relationship between categories, and operates each of the NE-OPSs by referring to the materials. However, the operator must operate the NE-OPS of each category individually. Thus, for example, in the case where the operator sets a path extending over two or more categories, there may occur setting errors.

Further, the recent NEs and NE-OPSs have been becoming more inexpensive and smaller due to execution of cost reduction etc. In other words, the NEs have been decreasing in the number that can be managed by one NE-OPS. Thus, in the larger-scale network, the number of NE-OPSs belonging to the same category increases. Therefore, the operator tends to carry more loads.

Accordingly, the current integration network is divided and operated on a category basis (per category) and on an NE-OPS basis (per NE-OPS). Thus, the operator must be always sensitive to the relationships (connection relationships between categories) between the network and the NE and between the network and the NE-OPS, identify a plurality of NE-OPSs to be operated, and execute the operations of the identified plurality of NE-OPSs individually. Therefore, the total management and operation (unitary management) of the integration network put heavy loads on the operator.

Demanded from the above-mentioned circumstances is a system for unitarily managing the integration network according to the TMN recommendations. To meet the demand, there is a technique (hereinafter, referred to as “conventional technique”) of making a management system having a function of integral management of a plurality of NE-OPSs belonging to various categories as well as a function of controlling the NE-OPSs.

However, the conventional technique requires development of functions equivalent to those of the NE-OPSs and the function of integral management. This leads to an increase in the scale of the development of the management system. The increase in the scale of the development elongates a development period (period required for building a management system). Therefore, it is difficult to meet the demand by providing a management system at an appropriate timing (timely).

Further, there may have developed an enhancement (upgrade) of a given NE and/or a new network category when the development of the management system is completed. In the case where an innovation has occurred, further development is required. Accordingly, the conventional technique has difficulties in providing a management system that follows network innovations appropriately.

As described above, the conventional technique may lead to the increase in the scale of the development, and may produce merely ordinary contents at the time of being provided. In addition, the scale of a system to be developed is large, making it difficult to follow the network innovations.

Further, as prior arts related to this application, there are a technique disclosed in the following Patent Document 1 (hereinafter, referred to as “Prior Art 1”) and a technique disclosed in the following Patent Document 2 (hereinafter, referred to as “Prior Art 2”).

Prior Art 1 discloses a network multi-layer management system including a user interface that allows cooperation (linkage) operations between layers. Prior Art 1 is characterized in that user interfaces per layer are separated from managers per layer, the user interfaces are mounted to an integrated interface module, and the cooperation operations are performed between the user interfaces. However, in Prior Art 1, reevaluation must be performed between the managers as to all functions included in the user interfaces separated from the existing system. In addition, communication interfaces must be provided between the user interfaces per layer, and moreover, decision must be made as to various protocols (error processing etc.) between the user interfaces.

Meanwhile, Prior Art 2 includes subnetwork managers that each manage subnetworks and a cooperation management manager that manages an end-to-end communication path in cooperation with a plurality of subnetwork managers in a hierarchical manner, and is characterized in that divided and relay management objects (MO) managed by each of the subnetwork managers work in cooperation with an end-to-end MO of the cooperation management manager to obtain a general scale of failures over the network and an influenced range. Accordingly, in Prior Art 2, the subnetworks are operated on a subnetwork manager basis (per subnetwork manager), and results of the operations are passed over to the cooperation management manager. Thus, there is no means for consulting the whole network when the subnetwork manager is used to set the network information, and an inconsistent (different in path accommodating location) path may be registered by the subnetwork manager. Therefore, there is a fear that the operator is provided with erroneous information.

It should be noted that as a prior art related to the present invention, there is a network management apparatus disclosed in the following Patent Document 3.

[Patent Document 1]
JP 10-124425 A

[Patent Document 2]
JP 09-247201 A

[Patent Document 3]
JP 11-331188 A

### SUMMARY OF THE INVENTION

It is an object of the present invention to provide an integration network management system that provides a network management system capable of controlling a scale of development.

Further, it is another object of the present invention to provide a network management system capable of reducing loads on an operator who manages a network.

The present invention provides a network management system, including: a management unit managing trail configuration information, trail name information, and work-related information related to trail management work as trail-related information related to trails that compose an integration network that is formed by integrating a plurality of networks belonging to different categories, and is provided with at least one network management apparatus in each category; and a calling unit calling a operation screen of the management apparatus that serves to execute the trail management work managed in a management apparatus side based on the trail-related information.

According to the present invention, the network management system is preferably configured such that: the management unit manages a work management table to register the work-related information including a category type to which the management apparatus belongs, a trail management work type, a trail type, and operation screen information of the management apparatus; and when the management apparatus to be operated and a category, the management work type, and the trail type thereof corresponding to a trail to be managed are designated, the calling unit provides the designated management apparatus with operation screen information corresponding to the designation registered in the work management table, and displays a operation screen based on the operation screen information obtained from the management apparatus on a display device.

According to the present invention, the network management system is preferably configured such that: a designation screen is provided for designating the management apparatus to be operated and the category, the management work type, and the trail type thereof corresponding to the trail to be managed; and the designation screen displays identification information of all management apparatuses to be operated which are related to the management work type of the trail.

According to the present invention, the network management system is preferably configured such that the management unit is provided in each category and includes a cooperating function unit for reading out corresponding operation screen information from the work management table and providing the operation screen information to the calling unit in the case where the category corresponding to the management unit itself is designated.

According to the present invention, the network management system is preferably configured so as to further include a registration screen providing unit providing a registration screen for registering trail configuration information and trail name information, and is preferably configured such that: the management unit manages a trail configuration management table into which the trail configuration information is registered; and the trail configuration management table stores one or more records including the trail type regarding a trail, presence/absence of an upper-layer trail accommodating the trail, an accommodation location of the trail in the upper-layer trail in the case where the upper-layer trail is present, and identification information of the management apparatus related to the management work for the trail, which are obtained through the registration screen.

According to the present invention, the network management system is preferably configured such that in the case where a plurality of upper-layer trails accommodating the trail is present, the trail configuration management table stores the records for respective upper-layer trails of the trail.

According to the present invention, the network management system is preferably configured such that: the management unit manages a trail name management table into which the trail name information is registered; and the trail name management table stores, per trail, a first trail name for managing the trail obtained through the registration screen and a second trail name set in each category related to the management work for the trail.

According to the present invention, the network management system is preferably configured such that: the registration screen providing unit provides a first trail name registration screen including an input field of a plurality of name elements that include the trail type of the trail to be registered; and the management unit includes a first trail name creating unit creating the first trail name based on a stack or combination of the plurality of name elements inputted through the first trail name registration screen, and registering the first trail name into the trail name management table.

According to the present invention, the network management system is preferably configured such that the registration screen providing unit presents a plurality of candidates for at least one name element, and the at least one name element is inputted with designation of one of the presented candidates.

According to the present invention, the network management system is preferably configured such that: the management unit includes a second trail name creating unit creating a second trail name by editing a first trail name according to an editing pattern prepared in each category; and the second trail name creating unit creates the second trail name in each category related to the management work for the trail to be registered, and registers the second trail name into the trail name management table.

According to the present invention, the network management system is preferably configured such that: in the case where the trail to be registered is accommodated in at least one upper-layer trail, the registration screen providing unit provides an accommodation location registration screen for registering the accommodation location of the trail in the upper-layer trail; and the accommodation location registration screen provides a search environment of the upper-layer trail, and displays accommodation states regarding the detected upper-layer trail.

According to the present invention, the network management system is preferably configured such that in the case where the trail to be registered is accommodated in a plurality of upper-layer trails, the accommodation location registration screen provides a work area for simultaneously registering accommodation locations of the trail in the upper-layer trails.

According to the present invention, the network management system is preferably configured such that in the case where the record of the trail accommodated in an upper-layer trail is registered in the trail configuration management table, the management unit registers the identification information of the management apparatus related to the management work for the upper-layer trail, which is already registered in the trail configuration management table, as identification information of the management apparatus related to the management work for the trail.

### BRIEF DESCRIPTION OF THE DRAWINGS

FIG. 1 is an explanatory diagram of an outline of a network management system;

FIG. 2 is a block diagram showing an operational outline of the network management system;

FIG. 3 is a conceptual diagram of an integration network, in which trail configurations are managed by the management system, and the trail configurations;

FIG. 4 is a conceptual diagram of a trail configuration management table that stores trail configuration information of the integration network;

FIG. 5 shows an example of a representation of a network based on the trail configurations;

FIG. 6 shows an example of a trail name management table managed by a trail management unit;

FIGS. 7A and 7B show an embodiment of a structure and method related to trail name registration;

FIG. 8 is an explanatory diagram showing an example of a work-category-basis NE-OPS cooperation table (a NE-OPS cooperation table for a work-category unit);

FIG. 9 is an explanatory diagram showing an example of a category-basis NE-OPS management table (NE-OPS management table for a category unit);

FIG. 10 shows a display example of a trail configuration input screen;

FIG. 11 shows an example of an SDH network and an example of accommodation display of the SDH network that uses the input screen shown in FIG. 10;

FIG. 12 shows how to operate an input screen for registering a new trail configuration (trail configuration registration screen);

FIG. 13 shows how to operate the input screen for registering a new trail configuration (trail configuration registration screen);

FIG. 14 shows an example of NE-OPSs of a category unit, NEs of a category unit, and an integration network composed of the NEs;

FIG. 15 shows cooperation OPS information of trail management managed by the network management system;

FIG. 16 shows an operational example of a management system (a Web terminal and the trail management unit) at the time of cooperation;

FIG. 17 shows a display example of an input screen at the time of cooperation;

FIG. 18 shows a display example of an input screen at the time of cooperation;

FIG. 19 shows a display example of an input screen at the time of cooperation;

FIG. 20 shows contents of the trail configuration management table for the operational example;

FIG. 21 shows how a trail having upper accommodation is automatically recognized;

FIG. 22 shows contents of the trail configuration management table for the operational example;

FIG. 23 shows how a trail having upper accommodation is automatically recognized;

FIG. 24 shows a operation flow of the network management system; and

FIG. 25 shows a screen input flow upon operation of the network management system.

### DETAIL DESCRIPTION OF THE PREFERRED EMBODIMENTS

Hereinafter, the drawings are referenced to describe a best mode for carrying out the present invention. A configuration described according to the following embodiment is merely an example, and the present invention is not limited to this embodiment.

<Outline>

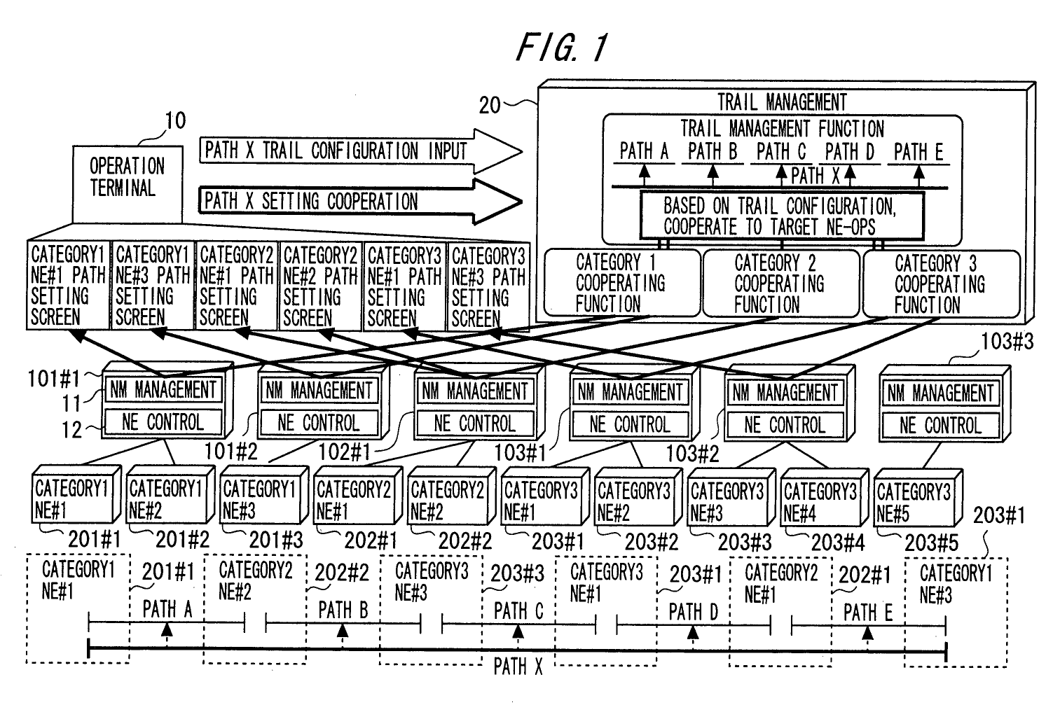

FIG. 1 is an explanatory diagram of an outline of a network management system (hereinafter, referred to merely as “management system”) according to the present invention. The management system realizes a network management system related to the NML (Network Management Layer) in the TMN recommendations, in which networks divided in each category are integrated.

As a premise, description will be made of an integration network to which the management system according to the present invention is applied. The integration network is obtained by integrating a plurality of networks (subnetworks) each belonging to one of different categories. In the example shown in FIG. 1, the integration network is obtained by integrating the subnetworks belonging to the categories 1 to 3.

Each category (network) includes at least one NE (transmission apparatus) and at least one NE-OPS (management apparatus) for managing and controlling a NE subordinated to the NE-OPS itself. In the example shown in FIG. 1, the category 1 includes two NE-OPSs (NE-OPSs 101#1 and 101#2). The NE-OPS 101#1 subordinates NEs 201#1 and 201#2. The NE-OPS 101#2 subordinates NE 201#3. Also, the category 2 includes one NE-OPS 102#1. The NE-OPS 102#1 manages and controls NEs 202#1 and 202#2. Also, the category 3 includes three NE-OPSs (NE-OPSs 103#1, 103#2, and 103#3). The NE-OPS 103#1 subordinates NEs 203#1 and 203#2. The NE-OPS 103#2 subordinates NEs 203#3 and 203#4. The NE-OPS 103#3 subordinates NE 203#5. It should be noted that “#X” contained in the reference symbols NE-OPSs and NEs denotes a number assigned to the NE-OPSs and NEs, where “X” is an integer equal to or more than 1.

In addition, the integration network shown in FIG. 1 includes trails as follows. Herein, the term “trail” represents a path (line). In FIG. 1, a path A is set between the NE 201#1 and the NE 202#2 (between categories 1 and 2). Also, a path B is set between the NE 202#2 and the NE 203#3 (between categories 2 and 3) Also, a path C is set between the NE 203#3 and the NE 203#1 (category 3). Also, a path D is set between the NE 203#1 and the NE 202#1 (between categories 3 and 2). Also, a path E is set between the NE 202#1 and the NE 201#3 (between categories 2 and 1). The paths A to E are realized by using physical lines made of, for example, optical fibers, which connect the NEs with one another.

In the integration network including such paths A to E, as shown in FIG. 1, logical connection (setting) is effected to obtain a path X. The path X is terminated at each of the NEs 201#1 and 201#3, and extends through the NEs 202#2, 203#3, 203#1, and 202#1.

Each NE-OPS is realized by using a computer that includes a processor (CPU or the like), a main memory, an auxiliary memory, and a communication control apparatus. In each NE-OPS, various programs (Operating System and applications) stored in the auxiliary memory are loaded into the main memory and executed by the processor. Thereby, an NM (Network Management) management function unit 11 for managing a network within a management range, and an NE control function unit (Network Element Management: NEM) 12 for controlling the subordinate NEs are realized.

The NM management function unit 11 manages various information for managing the network within the management range of the NE-OPS. In addition, the NM management function unit 11 has a function of providing operation screens (control screens) for operating the NE-OPS that is managed by an operator in response to a call instruction (activation instruction) from the operator. The NE control function unit 12 administers a processing of providing each NE subordinated to the NE-OPS with control instructions in response to an instruction from the NM management function unit 11.

It should be noted that the NM management function unit 11 and the NE control function unit 12 may be provided physically separately depending on the type of NE-OPS. However, a connection relationship (data send/receive or the like) between the NM management function unit 11 and the NE control function unit 12 is the same as the case where those are provided physically unitarily. Thus, such an NE-OPS is also included in the “management apparatus” according to the present invention. Conventional NE-OPSs and NEs may be used as the NE-OPSs and NEs described above except for a configuration (described later) involved in the operation screen call.

The management system includes a processor (CPU or the like) a main memory, an auxiliary memory, a communication control apparatus, an input apparatus (a keyboard and a pointing device (a mouse or the like)), and an output apparatus (a display and a printer), and can be realized by using at least one computer that is connected to each NE-OPS via a communication line. The at least one computer realizing the management system functions as the management system by the processor executing various programs (OS and application programs) stored in the auxiliary memory.

In the example shown in FIG. 1, the management system is realized by an operation terminal (for example, Web terminal) 10 of the operator and a computer (server apparatus) that realizes a trail management unit 20 connected to the operation terminal 10 via a communication line.

The operation terminal 10 has a function of displaying various screens involved in trail management work in response to the operation by the operator, and displaying an NE-OPS operation screen based on information sent from the trail management unit 20.

The trail management unit 20 manages a trail configuration composing the integration network, and provides the operation terminal 10 with information for calling a necessary NE-OPS operation screen from the NE-OPS. Accordingly, the trail management unit 20 realizes a function of registering/managing a trail configuration and a function of providing the operation terminal 10 with information for calling respective operation screens from a plurality of NE-OPSs to be operated (a plurality of NE-OPSs for cooperation) when work for managing the integration network (path settings or the like) is executed by the operator. The trail management unit may further have a function of registering/managing a trail name.

For example, as shown in FIG. 1, in the case where the operator operates (operates in cooperation) the plurality of NE-OPSs for setting (connecting) to the path X accommodated in each of the paths A to E, the operator registers trail configuration of the path X into the trail management unit 20 in advance. After that, the operator inputs to the trail management unit 20 an instruction related to the settings of the path X.

Then, the trail management unit 20 provides the operation terminal 10 with the information for calling the respective operation screens for setting the path X from the plurality of NE-OPSs (NE-OPSs 101#1, 101#2, 102#1, 103#1, and 103#2) to be operated in cooperation for setting the path X. Based on the information sent from the trail management unit 20, the operation terminal 10 obtains the corresponding setting screen from each NE-OPS and calls each screen onto a display. The operator uses each setting screen displayed on the display to input a setting instruction for the path X. The setting instruction inputted on the respective setting screen is provided to the corresponding NE-OPS. The NE control function units 12 of each of the NE-OPSs controls the NEs in which (at which or through which) the paths A to E are accommodated (terminated or passed) to thereby set the path X. Accordingly, the path X is set on the integration network.

As described above, in the trail management work by the operator, the management system can provide the operator with operation screens of a plurality of NE-OPSs to be cooperated with respect to the trail management work by obtaining the operation screens from the NE-OPSs based on trail configurations to be managed. Thus, the operator can execute desired management work merely by performing necessary data input work through the respective provided operation screens. Therefore, remaining settings can be prevented.

Further, in path management work including the path setting as described above, the operator does not need to grasp a relationship between categories and a relationship between the NE-OPSs such as which category each NE-OPS related to the path to be managed belongs to. Accordingly, the loads on the operator can be alleviated.

Further, the management system has the function of calling the operation screen managed on each NE-OPS side, which does not mean that part of the functions of NE-OPS is provided on the management system side (that the NM management function unit is integrated into the management system side). Therefore, the scale, period, and cost involved in the management system development can be suppressed.

<Operational Outline of Management System>

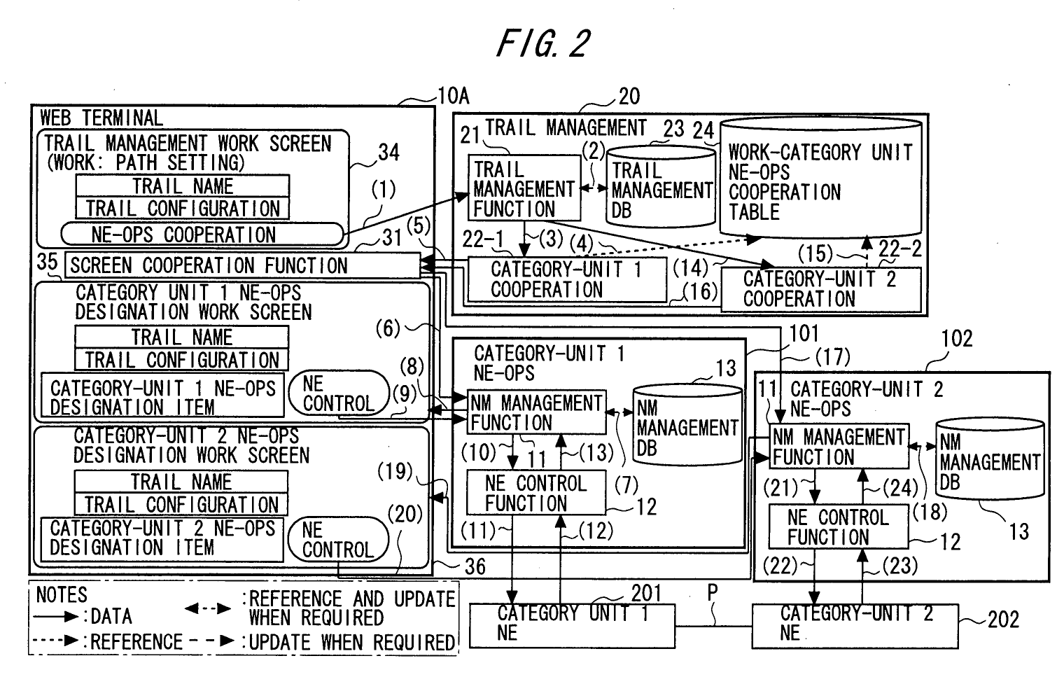

Next, description will be made of an operational outline of the management system. FIG. 2 is a block diagram showing the operational outline of the management system. In the example shown in FIG. 2, the management system includes a Web terminal 10A corresponding to the operation terminal 10, and the trail management unit 20.

In FIG. 2, the management system is connected through a network to an NE-OPS 101 belonging to the category 1 and an NE-OPS 102 belonging to the category 2 different from the category 1, and manages those NE-OPSs. In the example shown in FIG. 2, the NE-OPSs 101 and 102 are connected to the Web terminal 10A through the network.

The NE-OPS 101 is connected to a subordinate NE 201 (category 1) through a network for management and control. Meanwhile, the NE-OPS 102 is connected to a subordinate NE 202 (category 2) through a network for management and control.

The Web terminal 10A is operated by the operator of the integration network. The Web terminal 10A has a function (viewer; display control unit) caused by execution of a program to display various screens for executing the trail management work through the operator's operation of a plurality of NE-OPSs.

For example, as shown in FIG. 2, the Web terminal 10A displays a trail management work screen 34, designation work screen for NE-OPS of category unit 1 (operation screen for the NE-OPS 101) 35, and designation work screen for for NE-OPS of category unit 2 (operation screen for the NE-OPS 102) 36. For example, a Web browser can be used as the display control unit.

The Web terminal 10A includes a screen cooperation function unit 31 as one of the functions of the display control unit. In response to an instruction from the trail management unit 20, the screen cooperation function unit 31 administers the function of calling the operation screens of the NE-OPSs (in FIG. 2, the NE-OPSs 101 and 102) corresponding to the instruction from the NE-OPSs onto the display of the Web terminal 10A. In the example shown in FIG. 2, the screen cooperation function unit 31 displays the work screens 35 and 36 on the display of the Web terminal 10A.

The trail management unit 20 realizes a trail management function unit 21 and a cooperation function unit 22 provided in each category through execution of a program. Also, the trail management unit 20 includes a trail management database (trail management DB) 23 and a work-category-unit NE-OPS cooperation table 24.

The trail management unit 20 receives various information or data inputted by the operator through various screens (trail configuration registration screen, management work screen, etc.) displayed on the Web terminal 10A. The trail management unit 20 registers the received information into the trail management DB 23 if the information relates to the trail configuration. In contrast, if the information is an activation instruction for the operation screen of an NE-OPS, the trail management unit 20 passes the activation instruction over to the cooperation function unit 22 corresponding to the category to which the corresponding NE-OPS belongs.

The cooperation function unit 22 is provided in each category. In the example shown in FIG. 2, there are two categories (the categories 1 and 2). FIG. 2 thus shows a cooperation function unit 22-1 corresponding to the category 1 and a cooperation function unit 22-2 corresponding to the category 2.

It should be noted that the cooperation function unit 22 needs to function in consideration of characteristics of the work to be executed through operation of the NE-OPSs. Thus, in the case where the NE-OPSs belonging to one category are divided into a plurality of more-detailed types, the cooperation function unit 22 can be provided in each of the more-detailed types. Accordingly, the cooperation function can be divided for each category.

Since the cooperation function unit 22 is provided in each category, with regard to functions cooperated between categories, the cooperation function unit 22 can be created (independently of other categories) by being limited to the function relating to the corresponding category. Accordingly, when a new category is added to the integration network, a cooperation function unit 22 corresponding to the new category has only to be created.

Since the cooperation function unit 22 can be created independently (regardless) of the other categories, the cooperation function unit 22 can be created with ease. Then, cooperation can be executed between a new category and existing categories. On the other hand, when a category becomes unnecessary, the cooperation function unit 22 corresponding to the category may be deleted from the trail management unit 20. Accordingly, an increase or decrease in the number of categories does not influence the other categories.

The NE-OPSs 101 and 102 each include the NM management function unit 11 and the NE control function unit 12 as described with reference to FIG. 1 regardless of the category types. The NE-OPSs 101 and 102 each further include an NM management database (NM management DB) 13. The NM management database 13 is managed by the NM management function unit 11 and stores various information for managing networks within a management range of the NE-OPS. For example, the NM management DB 13 stores operation screen information of the NE-OPS, and the NM management function unit 11 supplies the Web terminal 10A with the corresponding operation screen information in response to the instruction from the management system.

FIG. 2 will be referenced to describe an operational example of the management system. FIG. 2 shows the operational example of the management system in the case where the operator executes management work (path setting work) for setting a path P between the NE 201 and the NE 202.

In the case of setting the path P, the operator manipulates the Web terminal 10A to calls the trail management work screen 34 onto the display. At this time, if the registration of the trail configuration of the path P is not complete, the operator can use the trail management work screen 34 to register the trail configuration of the path P into the trail management unit 20 [FIG. 2 (1), (2)].

When the registration of the trail configuration of the path P is complete, the operator designates an NE-OPS to be operated (as operation target) in cooperation for the setting of the path P and presses a cooperation button (activation button on the operation screen). Then, an instruction to call the operation screen is provided to the trail management function unit 21 of the trail management unit 20 [FIG. 2; (1)]. It is assumed here that the NE-OPS 101 is designated as a cooperation-destination NE-OPS, and the operation screen (path setting screen) call instruction is provided to the trail management unit 20.

The trail management function unit 21 specifies a category becoming a cooperation operation target from a category to which the cooperation-destination NE-OPS included in the call instruction belongs, and provides a cooperation instruction to the cooperation function unit 22-1 corresponding to the specified category (here, category 1) [FIG. 2; (3)]. The cooperation instruction includes a trail name and a work type (here, path setting) of the path P as a designation parameter.

Upon reception of the cooperation instruction from the trail management function unit 21, the cooperation function unit 22-1 references the cooperation table 24 with the designation parameter as a key. As a result of the reference of the cooperation table 24, the cooperation function unit 22-1 obtains screen activation information including location information (for example, URL (Uniform Resource Locator)) on the operation screen of the cooperation-destination NE-OPS (NE-OPS 101) corresponding to the designation parameter [FIG. 2; (4)].

The cooperation function unit 22-1 provides the obtained screen activation information to the screen cooperation function unit 31 of the Web terminal 10A [FIG. 2; (5)]. It should be noted that in recent years, a technique (Tarantella or the like) of capturing various screens into a Web page has been established as a Web technology. Thus, the operation screen of the NE-OPS can be captured into a Web page. In this example, by adopting the above-mentioned technique, each of the cooperation function units 22 each obtain the URL of the Web page into which the operation screen has been captured, and creates screen activation information as HTML (HyperText Markup Language) information, and the Web terminal 10A analyzes the HTML information as the screen activation information. However, the above-mentioned Web technology is not necessarily used, and it is sufficient that the management system can activate the operation screen of each NE-OPS of the cooperation operation target, on the operation terminal 10.

The screen cooperation function unit 31 analyzes the screen activation information received from the cooperation function unit 22-1, and provides the NE-OPS 101 with the activation instruction for the operation screen including the URL included in the screen activation information [FIG. 2; (6)].

Based on the activation instruction from the screen cooperation function unit 31, the NM management function unit 11 of the NE-OPS 101 reads out information on the operation screen (work screen 35) corresponding to the activation instruction managed by the NE-OPS 101 itself from the storage location (for example, NM management DB 13) [FIG. 2; (7)], and sends the information to the Web terminal 10A [FIG. 2; (8)]. The operation screen is originally prepared as the operation screen of the NE-OPS, and is provided according to screen transition due to operation of the NE-OPS itself. In response to the activation instruction, the screen cooperation function unit 31 calls the information on the operation screen to be activated based on the work type. At this time, in the case where the activation instruction includes the designation parameters such as the trail name and the trail configuration (for example, an accommodation location of a trail), the NM management function unit 11 can perform an editing processing on the information on the operation screen so as to display those designation parameters on the work screen 35.

Upon reception of the information on the work screen 35, the display control unit (Web browser) of the Web terminal 10A displays the work screen 35. At this time, in the case where the work screen 35 is being edited by the NM management function unit 11, the designation parameters (trail name and trail configuration) captured into the screen through the editing are displayed on the work screen 35. Accordingly, with the designation parameters being displayed, the operator can clearly grasp the target trail (path P). However, the displaying of the designation parameters is not an essential element to the present invention.

The work screen 35 displays a designation item necessary for operation of the NE-OPS 101 involved in work. The operator inputs the necessary designation item (control information on the NE) according to the displayed contents of the work screen 35. Here, the work screen 35 provides the operator with a user interface for inputting the designation item necessary for setting the path P, and the operator inputs the designation item (control/setting information on the NE to be controlled) necessary for setting the path P according to the displayed contents of the work screen 35. After that, the operator inputs an NE control instruction. The instruction can be inputted by, for example, pressing a button (for example, button “NE control”) provided on the work screen 35.

Upon input of the NE control instruction, the designation item (control/setting information on the NE) inputted through the work screen 35 is given to the NM management function unit 11 of the NE-OPS 101 [FIG. 2; (9)], given to the NE control function unit 12 through the NM management function unit 11 [FIG. 2; (10)], and given from the NE control function unit 12 to the NE 201 to be controlled [FIG. 2; (11)].

The NE 201 executes a processing (for example, connection processing for the path P) based on the control/setting information from the NE-OPS 101. Processing results of the NE 201 are returned from the NE 201 to the NE control function unit 12 of the NE-OPS 101 [FIG. 2; (12)]. Then, the final setting conditions from the NE 201 is provided to the NM management function unit 11 [FIG. 2; (13)], and stored in the NM management DB 13.

Subsequently, the operator designates the NE-OPS 102 as the cooperation-destination NE-OPS and inputs an instruction to call the operation screen [FIG. 2 (1)], and the trail management unit 20 and the Web terminal 10A perform the unit similar to the above.

To be specific, the trail management function unit 21 provides the cooperation instruction to the cooperation function unit 22-2 corresponding to the category (category 2) corresponding to the call instruction [FIG. 2; (14)].

The cooperation function unit 22-2 obtains the screen activation information including the location information (URL) on the operation screen corresponding to the designation parameter included in the cooperation instruction [FIG. 2; (15)], and passes the information to the screen cooperation function unit 31 of the Web terminal 10A [FIG. 2; (16)].

The screen cooperation function unit 31 analyzes the screen activation information, and provides the NE-OPS 102 with the activation instruction for the operation screen including the URL included in the screen activation information [FIG. 2; (17)].

Based on the activation instruction, the NM management function unit 11 of the NE-OPS 102 reads out information on the operation screen (work screen 36) corresponding to the activation instruction managed by itself from the storage location (for example, NM management DB 13) [FIG. 2; (18)], and sends the information to the Web terminal 10A [FIG. 2; (19)].

The display control unit of the Web terminal 10A displays the work screen 36 on the display based on the information on the work screen 36. The work screen 36 displays a designation item necessary for operation of the NE-OPS 102. The operator inputs the necessary designation item (control information on the NE) according to the displayed contents of the work screen. Then, the control/setting information on the NE inputted through the work screen 36 is provided to the NM management function unit 11 of the NE-OPS 102 [FIG. 2; (20)], provided to the NE control function unit 12 through the NM management function unit 11 [FIG. 2; (21)], and provided from the NE control function unit 12 to the NE 202 to be controlled [FIG. 2; (22)].

The NE 202 executes a processing (for example, connection processing for the path P) based on the control/setting information from the NE-OPS 102. Processing results of the NE 202 are returned from the NE 202 to the NE control function unit 12 of the NE-OPS 102 [FIG. 2; (23)]. Then, the final setting conditions from the NE 202 is provided to the NM management function unit 11 [FIG. 2; (24)], and stored in the NM management DB 13. According to the cooperation operation as described above, the operator can set the path P between the NEs 201 and 202.

<Trail Configuration Management>

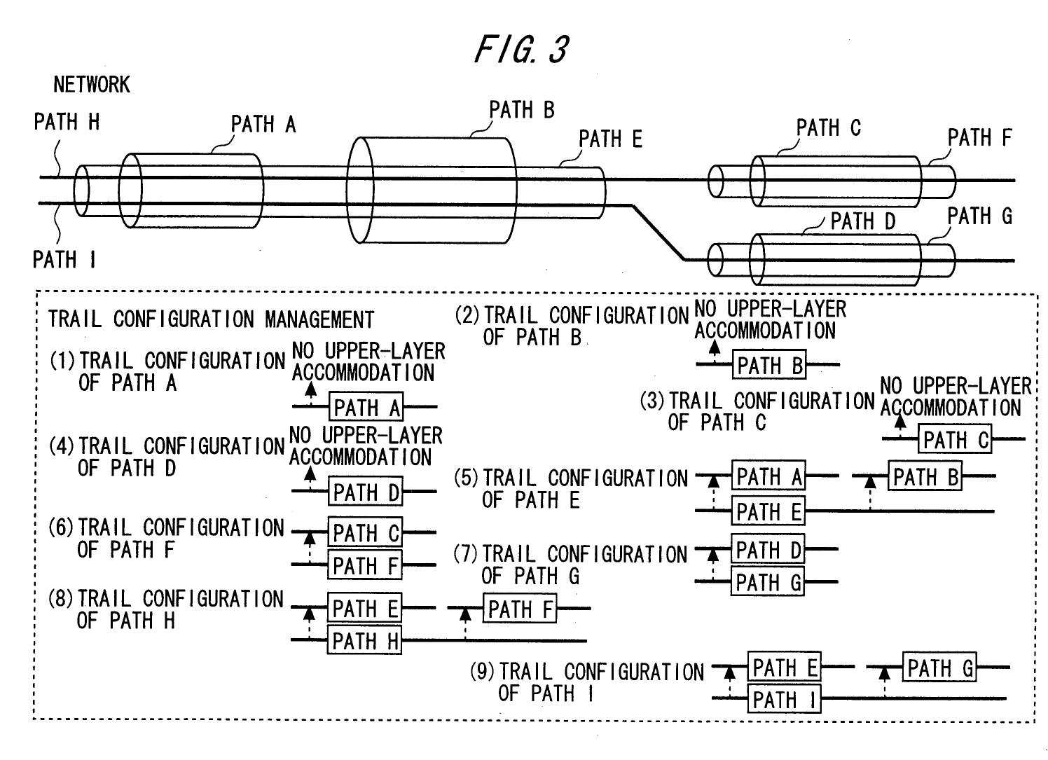

Next, description will be made of trail configuration management executed by the management system. FIG. 3 is a conceptual diagram of an example of the integration network, in which trail configurations are managed by the management system, and the trail configurations of the integration network.

As the “trail configuration management”, the management system manages at least each trail (own path) set in an integration network, an upper-layer path (trail) accommodating the own path in a layer directly above the own path, and information on an accommodation order in the case where the own path is accommodated in a plurality of upper-layer paths.

In the example shown in FIG. 3, the paths A, B, C, and D correspond to uppermost-layer paths whose upper-layer paths do not exist. With regard to the uppermost-layer paths, the management system manages own path information and information indicating that there does not exist its upper-layer path (no upper-layer accommodation) as trail configuration information. In this case, there is no accommodation order information.

Meanwhile, with regard to the paths accommodated in their upper-layer paths (in the example of FIG. 3, paths E, F, G, H, and I), the management system manages the own path information, accommodation information, and the accommodation order (connection order) information as the trail configuration information. The accommodation information includes the accommodation location of the own path within its upper-layer path.

FIG. 3 shows the trail configuration information of each of the paths A to I. Here, description will be made by taking the trail configuration of the paths E and I as an example. The path E is accommodated in the paths A and B, and the paths A and B correspond to the upper-layer paths. Here, in the integration network shown in FIG. 3, the accommodation order is determined, for example, in an order from the left side being an upstream side (so that a location closer to the left side imparts a higher order). Therefore, as the trail configuration information of the path E, the management system manages information indicating the path E, information indicating its upper-layer paths A and B, information indicating the accommodation location of the path E within the paths A and B, and the accommodation order of the path E (first: path A, second: path B). Meanwhile, the path I is accommodated in the paths E and G, and the paths E and G correspond to the upper-layer paths. Therefore, as the trail configuration information of the path I, the management system manages information indicating the path I, information indicating its upper-layer paths E and G, information indicating the accommodation location of the path I within the paths E and G, and the accommodation order of the path I (first: path E, second: path G).

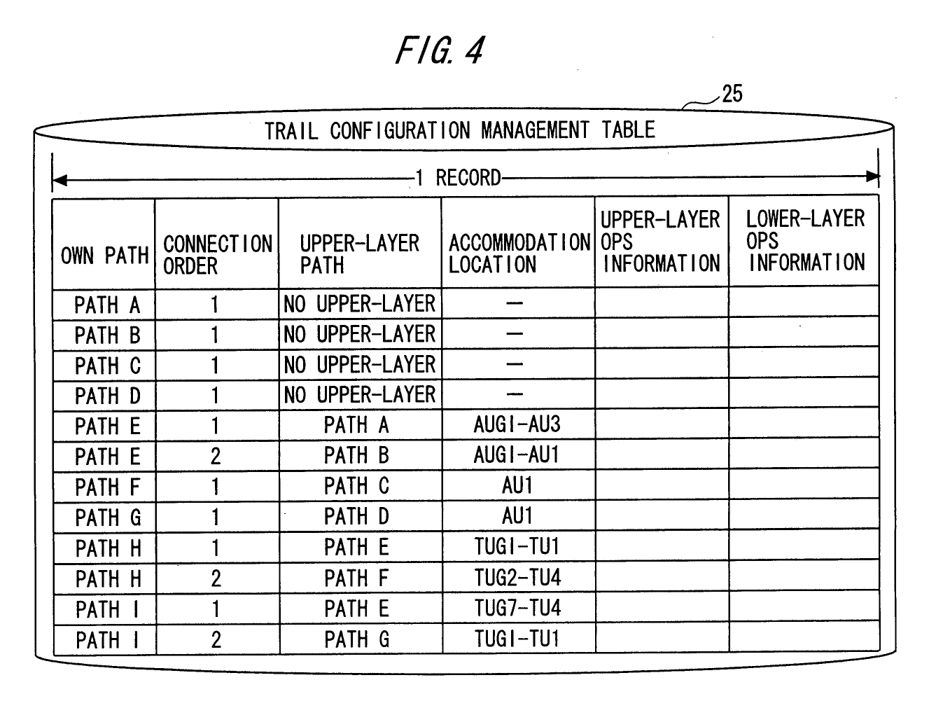

The management system can manage the trail configuration information on all the trails (paths) set in the integration network. FIG. 4 is a conceptual diagram of a trail configuration management table 25 that holds (stores) trail configuration information of the integration network. FIG. 4 shows an example state where the trail configuration information of the integration network as shown in FIG. 3 are stored.

As shown in FIG. 4, the trail configuration information is held/managed in the trail configuration management table 25. The trail configuration management table 25 includes one or more entries (records) that each store information indicating an own path, an accommodation order (connection order), an upper-layer path, an accommodation location, an upper-layer OPS, and a lower-layer OPS.

In the case where a path is accommodated in a plurality of upper-layer paths, an entry of the path is created for each upper-layer path. It should be noted that the information (sometimes referred to as “cooperation OPS information”) indicating the upper-layer OPS and the lower-layer OPS corresponds to endpoint information (as will be described later). The trail configuration management table 25 is created, for example, within the trail management DB 23 shown in FIG. 2. The contents of the trail configuration management table 25 are newly registered (added), modified, and deleted by the trail management function unit 21.

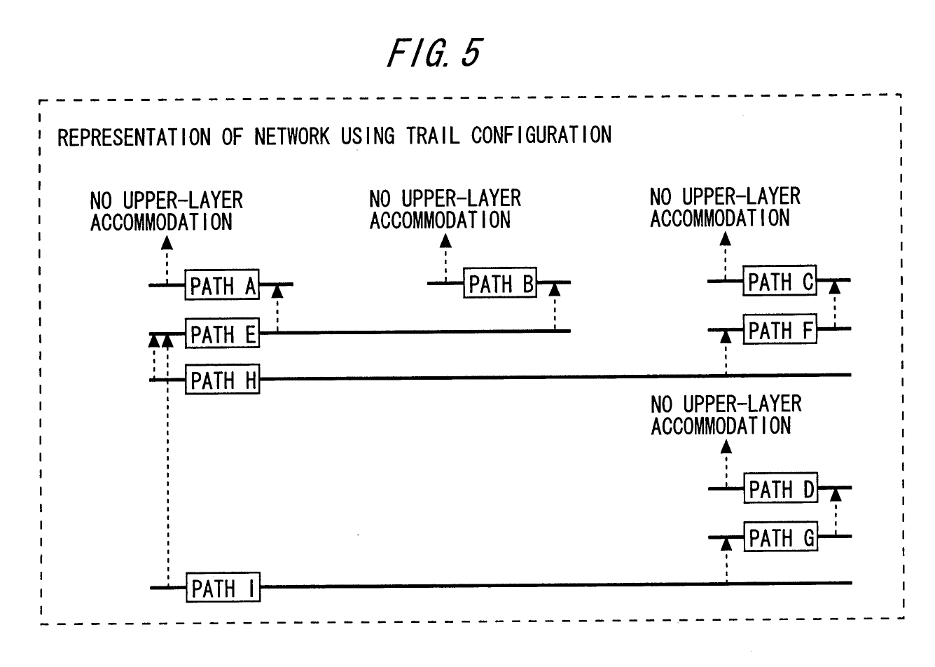

As described above, the management system includes the trail configuration management table 25. This allows a representation of the entire integration network as shown in FIG. 5. For example, in the case where the management system detects the trail configuration information (entry) related to the path H, the information indicating the paths E and F corresponding to the upper-layer paths of the path H can be obtained. If the management system detects the trail configuration information of the path E based on the above, the information indicating the paths A and B corresponding to the upper-layer paths of the path E can be obtained. Similarly, the management system can obtain the configuration of the path C (path C information) corresponding to the upper-layer path of the path F. It is apparent that the paths A, B, and C have no upper-layer paths from their trail configuration information.

Accordingly, the network management system can recognize that all the trail configurations related to the path H are obtained. Then, the representation of the network configuration related to the path H as shown in FIG. 5 is possible. Therefore, it is possible to detect the trail configuration information of all the paths existing in upper layers with respect to a path taken as a starting point. Accordingly, the representation of the entire integration network is possible by following paths from the lowermost-layer path to the upper-layer paths in order. In the example shown in FIG. 5, if the paths H and I are set as the starting points, the trail configurations of the entire can be obtained, thereby allowing the representation of the entire integration network.

It is also possible to reversely follow paths from the uppermost-layer path to lower-layer paths in order, thereby allowing the representation of the entire integration network. For example, in FIG. 5, if the lower-layer paths are followed from the path B, the management system searches for (retrieves) the entry of a path having the path B as its upper-layer path. As a result, the entry of the path E is detected. Subsequently, the management system searches for the entry of a path having the path E as its upper-layer path. As a result, the entries of the path H and the path I are obtained. Subsequently, the management system searches for the entry of a path having the path H or I as its upper-layer path. Thereby, a search result indicating that there are no corresponding entries is obtained. Thus, it is determined that the paths H and I are the lower most-layer paths. Therefore, the trail configuration information of all the lower-layer paths related to the path B is obtained, and the information on the paths from the path B to the lowermost-layer paths (paths H and I) can be used to represent the network related to the path B. Further, if the management system performs the same unit as the unit related to the path B on the other uppermost-layer path (paths A, C, and D), all the trail configurations of the integration network shown in FIG. 5 can be obtained, thereby allowing the representation of the entire integration network.

It should be noted that the configurations in the trail configuration management table 25 shown in FIG. 4 can also be used to follow paths from the uppermost-layer path to the lowermost-layer path. If the trail configuration management table 25 shown in FIG. 5 is adapted so that each entry therein holds information on the path accommodated in the own path in a layer directly under the own path (an item “lower-layer path” is added to each entry), it is possible to use the entry of the uppermost-layer path to obtain therefrom the trail configuration information on all the paths existing under the uppermost-layer path.

The operator manipulates the operation terminal 10 (Web terminal 10A) and controls the trail management function unit 21 to thereby allow the execution of a path search processing as described above. Further, it is possible to display on the display the search results of the trail configuration information and the trail configurations of the network using the search results.

<Trail Name Management>

Next, description will be made of trail name management executed by the management system. The trail management unit 20 can include a trail name in the designation parameter upon execution of cooperation of the NE-OPS. Thus, the trail management unit 20 manages the trail name in the following manner.

The management system manages, as the trail name, a trail name for managing the own path in the trail management unit 20 (referred to as “trail-management trail name (first trail name)”) and a trail name prepared for each category-unit NE-OPS that performs cooperation for the own path (referred to as “category-unit NE-OPS trail name (second trail name)”).

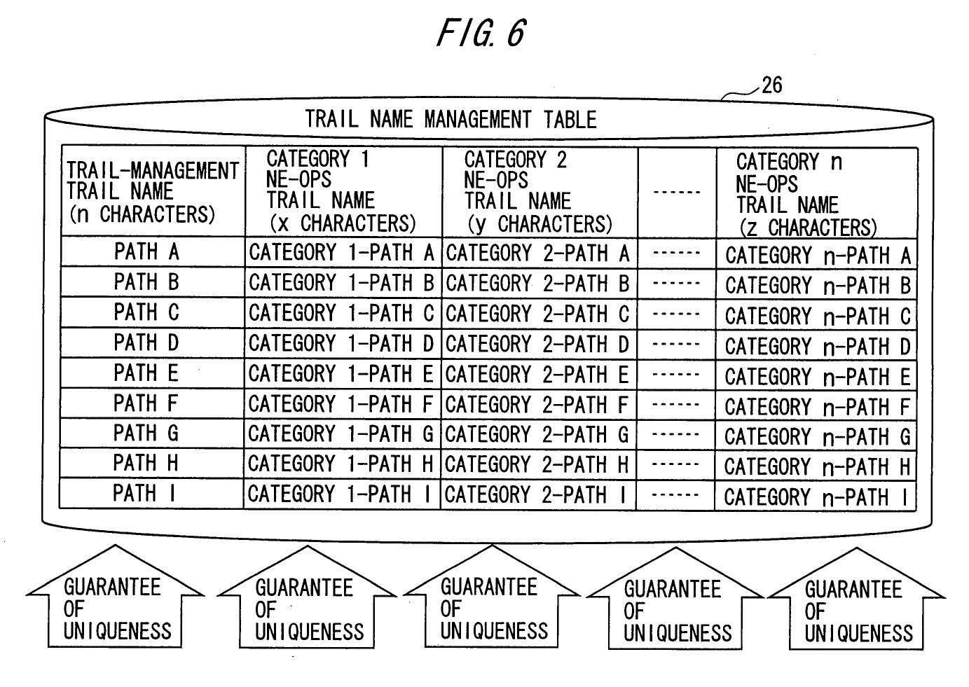

FIG. 6 shows an example of a trail name management table 26 managed by the trail management unit 20. The trail name management table 26 includes one or more entries (records) prepared for each trail (own path), and each of the entries have fields for holding the trail-management trail name and the category-unit NE-OPS trail names.

The trail-management trail name and the category-unit NE-OPS trail name are guaranteed to have uniqueness, and the trail name has uniqueness guaranteed on the basis of the trail (own path) (per trail) and on the basis of the category-unit NE-OPS (per category-unit NE-OPS).

The trail name management table 26 is provided, for example, within the trail management DB 23 shown in FIG. 2, and its contents are newly registered and updated (added, modified, and deleted) by the trail management function unit 21. The operator operates the operation terminal 10 (Web terminal 10A) to control the trail management function unit 21, and can register the trail name into the trail name management table 26.

FIG. 6 shows the contents held in the trail name management table 26 with respect to the integration network shown in FIG. 3. In this example, the trail name management table 26 includes the entries corresponding to the paths A to I, respectively. The trail-management trail name is used to specify the own path. The category-basis NE-OPS trail name is used to specify the own path on the basis of the category-unit NE-OPS cooperation for the work related to the own path.

The operator may define and register every trail-management trail name and every category-unit NE-OPS trail name into the trail name management table 26. However, work for name registration is heavy loads on the operator. Therefore, such configuration and method as shown below can alleviate the loads on the operator.

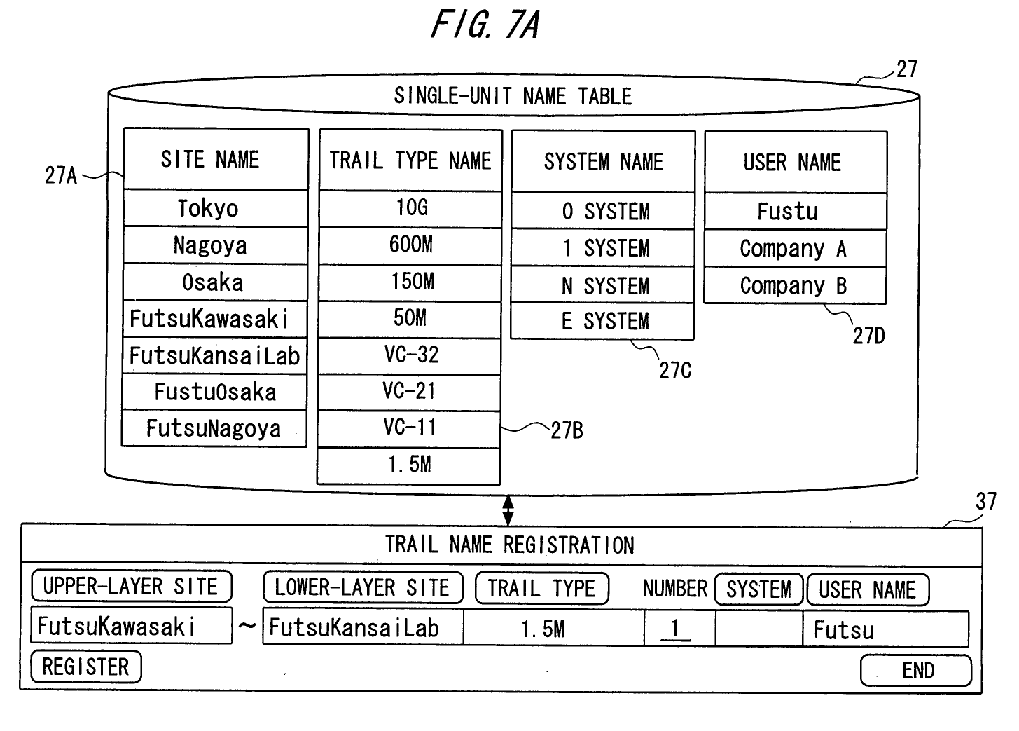

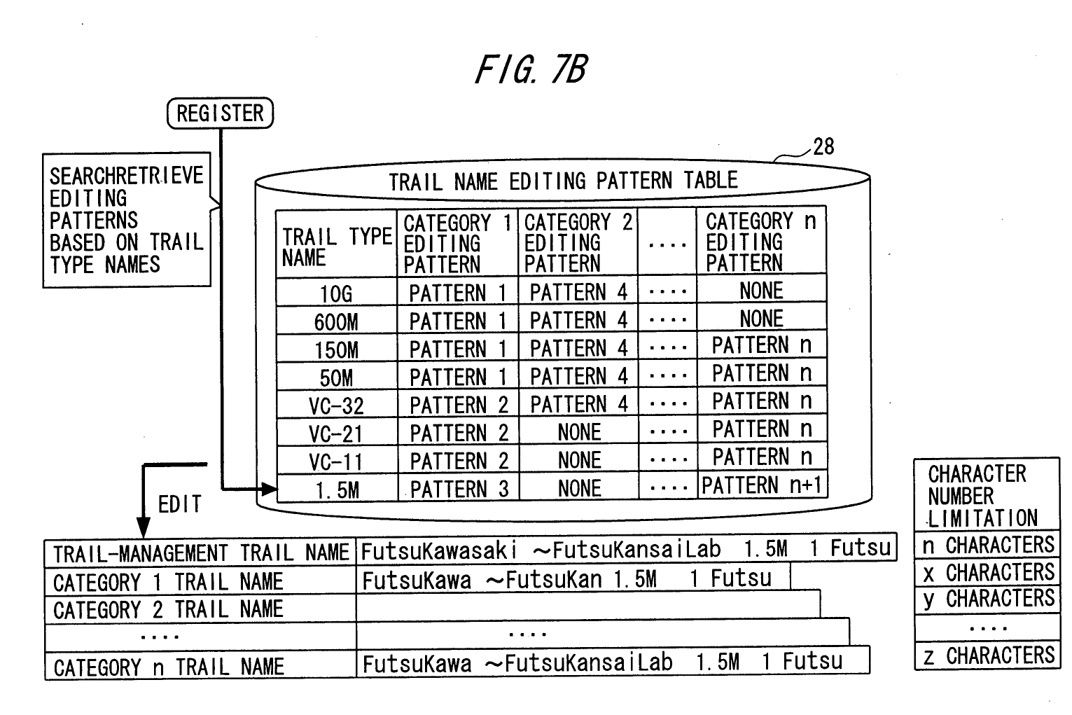

Next, FIG. 7 will be used to describe a configuration and method for guaranteeing the uniqueness of the trail-management trail name and the category-unit NE-OPS trail name. The trail-management trail name and the category-unit NE-OPS trail name have the number of characters of their names defined in advance so as to avoid an overlapping name.

In the example shown in FIG. 7, the number of characters of the trail-management trail name is defined as n, and the numbers of characters of the category-unit NE-OPS trail names are defined as x, y, . . . z in the categories 1, 2, . . . , n, respectively. Here, n, x, y . . . , z denote mutually different integers equal to or larger than 1. This example satisfies the relationships of “x<y<z” and “n≠x, y, z”. The relationship of “x<y<z” may be the relationship of “x>y>z”.

Accordingly, the numbers of characters are different between the trail-management trail name and the category-unit NE-OPS trail name and among the category-unit NE-OPS trail names. Therefore, each name is represented by using a character string having the number of characters (including blanks) defined for the name, and the character string is adopted as the trail name, so that the uniqueness of the name is guaranteed.

FIGS. 7A and 7B show an example of a structure and a method related to trail name registration. For the trail name registration, the management system can include a single-unit name table 27 as shown in FIG. 7A and a trail name editing pattern table 28 as shown in FIG. 7B. The single-unit name table 27 and the trail name editing pattern table 28 are provided, for example, within the trail management DB 23 (see FIG. 2).

Further, upon being called by the operator, the management system displays a trail name registration screen 37 on the display of the operation terminal 10 (Web terminal 10A). Information displayed on the trail name registration screen 37 is stored, for example, in the trail management DB 23, and provided to the operation terminal 10 (Web terminal 10A) by the trail management function unit 21 in response to an instruction from the operator.

The trail name registration screen 37 includes input fields for a plurality of items related to trail configurations as displayed contents for allowing the operator to assign (defining) the trail-management trail name to the own path. In the example shown in FIG. 7A, the trail name registration screen 37 includes input fields for the names (referred to as “single-unit names”) of respective items of “upper-layer site (starting point of the own path)”, “lower-layer site (endpoint of the own path)”, “trail type”, “number”, “system”, and “user name” with regard to the own path. When the operator inputs single-unit names corresponding to the respective items, the trail-management trail name is created based on a combination or stack of the inputted single-unit names.

The single-unit name table 27 is provided to alleviate the loads on the operator who inputs the single-unit names into the respective input fields of the trail name registration screen 37. The single-unit name table 27 is composed of a plurality of small tables. The plurality of small tables each stores a group of single-unit names to be single-unit name candidates on the basis of a single-unit name category.

FIG. 7A shows, as the examples of the small table, a site name small table 27A that stores the candidates of the “upper-layer site” and the “lower-layer site”, a trail type name small table 27B that stores the candidates of the trail type, a system name small table 27C that stores the candidates of the system name, and a user name small table 27D that stores the candidates of the user name.

The trail name registration screen 37 has buttons, each for displaying the candidates of the single-unit name, provided along with each input fields. When the operator inputs any one of the buttons, contents stored in the small table corresponding to the button (a list of the single-unit name candidates) are outputted on the display. When the operator specifies any one of the candidates by selection from the list of the candidates, the specified single-unit name is displayed in the corresponding input field. The operator specifies one by one the candidates (upper-layer site, lower-layer site, trail type, system, and user name) corresponding to the own path to be a trail name registration target.

The trail name registration screen 37 includes a registration button (in FIG. 7A, “register” button) for causing the trail management unit 20 to start the trail name registration processing. For example, when the registration button is pressed after the operator specifies or inputs the single-unit name, the trail management function unit 21 (FIG. 2) starts the trail name registration processing.

As shown in FIG. 7B, the trail management function unit 21 receives the single-unit names specified on the trail name registration screen 37, and stacks them in a predetermined order in a range of the defined number of (n) characters to thereby create the trail-management trail name (n characters) and register it into the trail name management table 26.

Meanwhile, the trail management function unit 21 edits the single-unit names (or trail-management trail names) specified in the trail name registration screen 37 by using the trail name editing pattern table 28. Accordingly, the trail name (category-unit NE-OPS trail name) is created for each category-unit NE-OPS related to the own path.

The trail name editing pattern table 28 is composed of entries prepared for each trail type name stored in the small table 27B. The entries holds definition information on editing patterns of the trail-management trail names in categories 1, 2, . . . , n−1, n corresponding to the trail type names, respectively. It should be noted that the trail name editing pattern table 28 can define the pattern as “no editing pattern” instead of the editing pattern because a certain trail type may not be managed by the NE-OPS in a certain category. In other words, in this example, a category related to the trail management work is specified based on the trail type.

The example of the trail name editing pattern table 28 shown in FIG. 7B indicates that trail types “VC-21”, “VC-11”, and “1.5M” are not managed by the NE-OPS in the category 2. Similarly, it is indicated that trail types “10G” and “600M” are not managed by the NE-OPS in the category n.

The trail management function unit 21 searches the trail name editing pattern table 28 with the trail type specified in the trail name registration screen 37 as a key to detect the editing pattern corresponding to the trail type.

Subsequently, the trail management function unit 21 edits a group of the single-unit names specified based on the detected editing pattern. Accordingly, the trail management function unit 21 creates the category-unit NE-OPS trail names corresponding to a plurality of NE-OPSs in cooperation in terms of the own path, respectively.

FIG. 7B shows an example of the trail name editing. In other words, FIG. 7B shows the trail-management trail names and category-unit NE-OPS trail names in the case where an upper-layer site “FutsuKawasaki”, a lower-layer site “FutsuKansaiLab”, a trail type “1.5M”, a system “1”, and a user name “Futsu” are specified. In this example, the trail management function unit 21 creates the trail-management trail name “FutsuKawasaki-FutsuKansaiLab 1.5M 1 Futsu” created by stacking the single-unit names by the number of n characters.

Subsequently, the trail management function unit 21 reads out each of the editing patterns corresponding to the trail type name “1.5M” from the trail name editing pattern table 28, and processes the group of single-unit names according to the respective editing patterns. For example, the editing patterns have definitions of editing work for stacking the group of the single-unit names so that the category-unit NE-OPS trail names differ from the trail-management trail name and also differ among categories. For example, the editing pattern (pattern 3) in category 1 corresponding to the trail type name “1.5M” has the definition that the number of component characters is smaller than that of the trail-management trail name (number of component characters: n>x), and that a limitations in the number of characters (effective number of characters: 3) of the single-unit names indicating the upper-layer site and the lower-layer site. According to the definition of the pattern 3, the trail management function unit 21 creates the category-basis NE-OPS trail name in the category 1, “FutsuKawa-FutsuKan 1.5M 1 Futsu”.

On the other hand, the editing pattern (pattern n+1) corresponding to the category n has a definition that the number of component characters is larger than that of the trail-management trail name (number of component characters: n<z). In this case, the trail management function unit 21 inserts a blank (space) between appropriate single-unit names within the trail-management trail name. This allows the creation of the category-unit NE-OPS trail name in the category n which has the larger number of component characters than that of the trail-management trail name.

It should be noted that in the example shown in FIG. 7B, the trail type “1.5M” does not manage the category 2, so that the category-unit NE-OPS trail name in the category 2 is not created. The trail management function unit 21 registers the created category-unit NE-OPS trail name in each category into a predetermined entry of the trail name management table 26 (see FIG. 6).

As described above, according to the embodiment of the management system, in order to define the trail names (trail-management trail names and category-unit NE-OPS trail names) the single-unit names are managed as the cores of the trail names. Then, a plurality of single-unit names specified by the operator are stacked, and combinations of the single-unit names are edited. This allows the creation of the trail-management trail names and the category-basis NE-OPS trail names. According to the above-mentioned configuration, the combinations of the single-unit names differ among the own paths, so that the uniqueness of the trail name (trail-management trail name) of each own path is guaranteed.

Further, a plurality of category-basis NE-OPS trail names with respect to a certain own path are created based on the editing patterns different from one another among categories, thereby guaranteeing the uniqueness of the category-unit NE-OPS trail name.

Further, the limitation in the number of component characters of each category-unit NE-OPS trail name is different from that of the trail-management trail name, so that those names are mutually different. This guarantees the uniqueness between the trail-management trail name and the OPS trail name.

Further, the operator specifies a plurality of single-unit names corresponding to the own path, whereby the trail-management trail names and the category-unit NE-OPS trail names are automatically created. This alleviates the loads on the operator who works on the trail name registration.

<NE-OPS Cooperation Information Management>

Next, description will be made of an embodiment of the NE-OPS cooperation information management for the network management system. Upon operation in response to a cooperation instruction from the trail management function unit 21, the cooperation function unit 22 of the trail management unit 20 references the work-category-basis (work-category-unit) NE-OPS cooperation table 24.

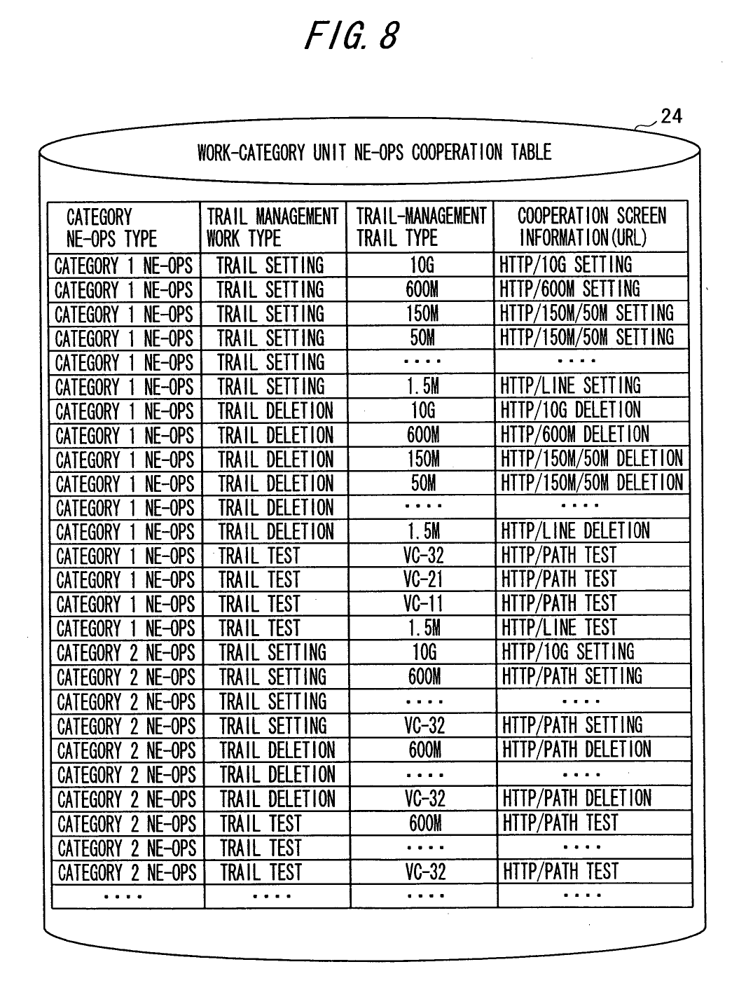

FIG. 8 is an explanatory diagram showing an example of the work-category-unit NE-OPS cooperation table 24 (hereinafter, referred to as “cooperation table 24”). On the basis of a category-unit NE-OPS type, the cooperation table 24 stores a plurality of entries (records) each defining a management work type, a management trail type, and cooperation screen information (a URL of the operation screen of the NE-OPS). In other words, each entry stores information (in this example, a URL (Uniform Resource Locator)) indicating the location that stores a operation screen of the NE-OPS corresponding to a category-unit NE-OPS type, a work type, and a trail type.

Here, the category-unit NE-OPS type represents a category to which the NE-OPS belongs. The work type represents a type of management work. The management work includes, for example, “trail setting”, “trail deletion”, and “trail tests”.

The cooperation table 24 holds only the cooperation screen information of NE-OPSs in cooperation in terms of a work type and a trail type, as entries. In other words, when defining the NE-OPS type, the work type, and the trail type for specifying the cooperation screen information, if there is no need for the cooperation in terms of the work type and the trail type, the cooperation screen information is not defined.

The cooperation function unit 22 (FIG. 2) receives the category-unit NE-OPS type, the work type, and the trail type from the trail management function unit 21, and searches the cooperation table 24 for the cooperation screen information (URL) with those as keys. As a result of the search of the cooperation table 24, that is, based on the presence/absence of the cooperation screen information, the cooperation function unit 22 judges whether or not the NE-OPS is subjected to cooperation.

For example, the cooperation table 24 is created and updated within the trail management unit 20 by the operator's control of the trail management function unit 21.

<NE-OPS Management>

Next, description will be made of an embodiment of NE-OPS management for the network management system. A data structure of the cooperation table 24 shown in FIG. 8 presupposes that one NE-OPS belongs to one category. However, the integration network managed by the network management system may have a plurality of NE-OPSs in one category. In this case, the data structure of the cooperation table 24 shown in FIG. 8 cannot specify one NE-OPS from a plurality of NE-OPSs belonging to a certain category. Thus, the management system includes a category-unit NE-OPS management table 29 for managing one or more NE-OPSs belonging to each category.

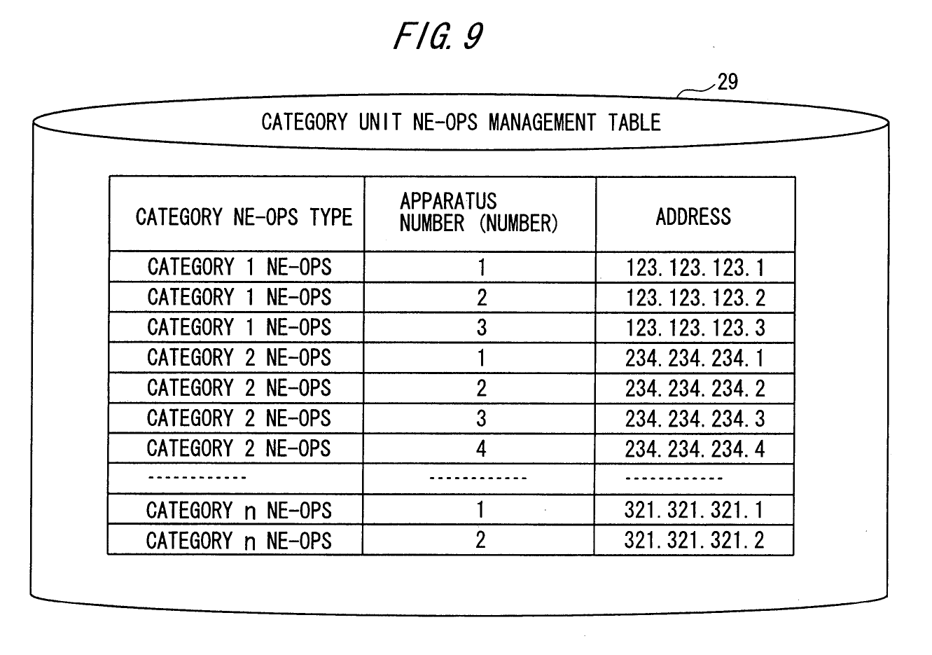

FIG. 9 is an explanatory diagram showing an example of a category-unit NE-OPS management table (hereinafter, referred to as “management table”) 29. The management table 29 holds one or more entries (records) each including information indicating the category to which an NE-OPS belongs (category-unit NE-OPS type) identification information of the NE-OPS within the category (the number for the NE-OPS: previously assigned), and location information of the NE-OPS, as information for specifying one or more NE-OPSs belonging to each category.

The location information of the NE-OPS is, for example, an address obtained in a unit by which the NE-OPS exists physically (a unit of a target for which cooperation is executed.). This example shows an IP address of the NE-OPS.

Accordingly, the management system uses the cooperation table 24 to manage the definitions of fixed elements of each category-unit NE-OPS, and uses the management table 29 to manage the definitions of fluctuated (variable) elements of each category-unit NE-OPS. In other words, information on the category-unit NE-OPSs is managed independently of the cooperation screen information on trail-related work. Thus, the management system may only need to update the management table 29 with respect to fluctuation (addition or deletion) of the NE-OPSs in a certain category. In other words, the fluctuation of the NE-OPSs has no influence on the contents held by the cooperation table 24.

Therefore, the contents of the cooperation table 24 do not need to be modified regardless of the number of the NE-OPSs belonging to each category. Accordingly, the trail management becomes easy. In addition, it is possible to minimize the range of modifying information for managing a trail due to the fluctuation of the NE-OPSs.

With regard to the addition/deletion of the category-unit NE-OPS, cooperation settings become possible by modification of the category-unit NE-OPS management table 29.

<Trail Configuration Input>

The trail management unit 20 shown in 2 manages such trail configurations as described with reference to FIGS. 3 and 4. The trail configuration is registered into the trail management DB 23 of the trail management unit 20 by operation of the operation terminal 10 (or Web terminal 10A). Here, in the case where the operator registers the trail configuration, it is necessary to establish a technique that does not cause inconsistency on the trail management.

Thus, a technique is adopted in which if an upper-layer path (upper-layer trail: referred to also as “accommodation destination trail”) accommodating the own path (own trail) in a layer directly above the own path is selected upon trail configuration registration, the accommodation states of the upper-layer path are displayed, and the accommodation location of the own trail is determined. Accordingly, it is possible to prevent the occurrence of accommodation inconsistency (overlapping accommodation) in the trail management.

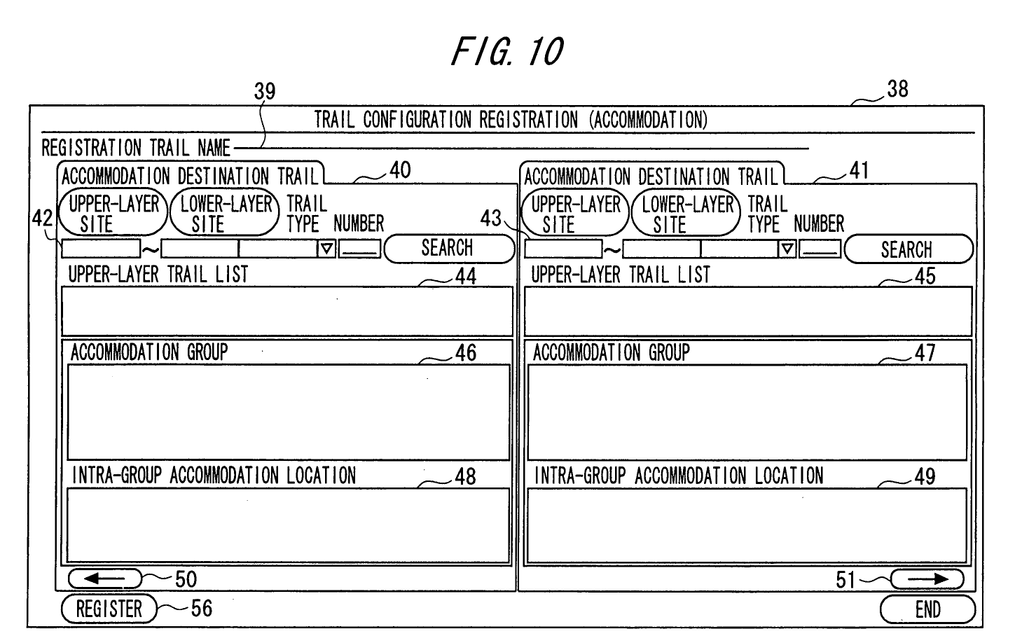

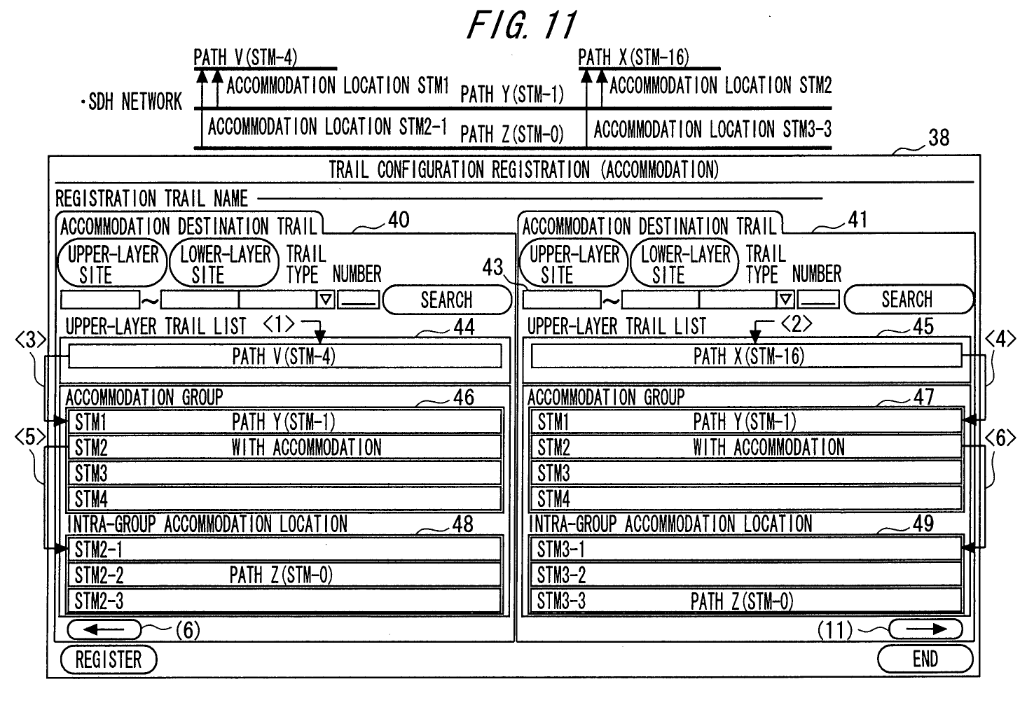

FIG. 10 shows an example of a trail configuration input screen 38. The trail configuration input screen 38 (hereinafter, also referred to as “input screen 38”) is called through operation of the Web terminal 10A onto its display. The input screen 38 displays a name of the own trail to be registered in a display in a registration trail name display field 39. Here, the above-mentioned trail-management trail name may be applied to the registration trail name.

Further, in the example shown in FIG. 10, the input screen 38 has a layout that allows simultaneous display of two fields (tabs). FIG. 10 shows the tabs 40 and 41 as the two tabs. The tabs 40 and 41 are each used to input information on the upper-layer trail of the own trail for each upper-layer trail, and display the information. The operator can use the tabs 40 and 41 to designate and confirm the upper-layer trails individually.

The tabs 40 and 41 have setting fields 42 and 43, respectively, of the search conditions for the upper-layer trail. The tabs 40 and 41 each include input or selection fields of an upper-layer site, a lower-layer site, a trail type, and a number, which function as elements (designation items) of the search conditions, and a search start button.

By inputting and selecting each element, the operator can set (designate) the search conditions for the accommodation destination trail. In the case where the trail-management trail name is applied as the registration trail name, the registration trail name is composed by combining the single-unit names to be inputted as the elements of the search conditions. This alleviates the loads on the operator who inputs the search conditions.

It should be noted that upon designation of the search conditions, it is unnecessary to specify all the items of the upper-layer site, the lower-layer site, the trail type, the number (designation of all items is unnecessary). When the search button is pressed after designating the search conditions, the trail management unit 20A searches for accommodation destination trails (upper-layer trails) that match the search conditions.

The tabs 40 and 41 further include upper-layer trail list display areas 44 and 45, respectively. The display areas 44 and 45 each display a list of trail names of upper-layer trails (accommodation destination trails) that match the search conditions specified in the setting fields 42 and 43.

By referencing the refined list displayed in the display area 44 or 45, the operator can designate the upper-layer trail that accommodates the own trail. Accordingly, compared to display of a simple list of trails, the above list reduces the probability that the operator makes erroneous selection. The designation is performed by designating with an input device (for example, mouse-clicking) any one of the upper-layer trails displayed on the list.

If the operator selects one trail from the list displayed in the display areas 44 or 45, the trail management function unit 21 searches the contents of the trail configuration management table 25 (FIG. 5) to extract a record corresponding to the selected trail. The contents of the extracted record are displayed on the corresponding tab as the accommodation states of the upper-layer trail.

The tabs 40 and 41 further include accommodation group display areas 46 and 47 and intra-group accommodation location display areas 48 and 49, respectively. The display areas 46, 47, 48, and 49 are provided for display, designation, and the like of the accommodation states of the upper-layer trails selected from the list or specified, and the accommodation locations of the own trails.

It will be described below why the display designation of the accommodation location is composed of the accommodation group and the intra-group accommodation location. The SDH (Synchronous Digital Hierarchy) is defined with STM-1 (Synchronous Transport Module-1=156 Mbit/s) as a basic unit. However, the Synchronous Digital Hierarchy in Japan also adopts STM-0 (52 Mbit/s) as a reference. Thus, the screen 38 is adapted to allow the simultaneous display and settings of STM-1 and STM-0 as the accommodation contents (accommodation states) of STM-n.

It should be noted that a path of STM-1 is created by bundling three paths of STM-0. Thus, the path of STM-1 composes an accommodation group consisting of the three paths of STM-0. A path of STM-n is created by bundling n (n being the multiples of 4) paths of STM-1. STM-n is standardized as STM-4, STM-16, and STM-64 at present.

FIG. 11 shows an example of an SDH network and an example of accommodation display of the SDH network that uses the trail configuration input screen 38 shown in FIG. 10.

In the SDH network shown in FIG. 11, a path V of STM-4 and a path X of STM-16 accommodate a path Y of STM-1 and a path Z of STM-0, respectively. The path Z is not included in a group of STM-0 composing the path Y, and the path Y is not the upper-layer path of the path Z.

In this case, the accommodation location (accommodation group of STM-0) of the path Y with respect to the path V is “STM1”. Also, the accommodation location (accommodation group of STM-0) of the path Y with respect to the path X is “STM2”. Also, the accommodation location (accommodation location within accommodation group) of the path Z with respect to the path V is “STM2-1”. Also, the accommodation location (accommodation location within accommodation group) of the path Z with respect to the path X is “STM3-3”.

In the case where the trail configurations of the SDH network shown in FIG. 11 are defined by the trail configuration management table 25 (FIG. 5), for example, when the search conditions are designated for the upper-layer trail of the path Z, the display areas 44 and 45 on the tabs 40 and 41 are displayed as the path V and the path X as the search results, respectively [<1> and <2> of FIG. 11].

At this time, when the path V and the path X are designated, the trail configuration management table 25 is searched to display the accommodation group of the path Z and the accommodation location within the accommodation group of the path Z on the display areas 46, 47, 48, and 49.

To be specific, the display areas (accommodation group fields) 46 and 47 display the path name of a path (in this example, the path Y) occupying the STM-1 equivalent. Also, “with accommodation” is displayed for a path (in this example, the path Z) occupying the accommodation in STM-0 [<3> and <4> of FIG. 11].

When the portion of “with accommodation” is selected or designated, the accommodation states are displayed in the corresponding intra-group accommodation location display area. In other words, three paths space of STM-0 composing the accommodation group are displayed, while the path names are displayed in the fields of STM-0 corresponding to the accommodation locations [<5> and <6> of FIG. 11]. It should be noted that the above-mentioned operation may be executed in series tab by tab, or may be executed in parallel between two tabs.

Referring again to FIG. 10, the input screen 38 is provided with two arrow buttons 50 and 51. The tabs on the input screen 38 are prepared depending on the number of upper-layer paths accommodating the path (own path) to be registered in a layer directly above the own path. However, the number of the tabs that can be displayed on the input screen 38 at a time is limited to two. The arrow buttons 50 and 51 are used to call the other tabs for the upper-layer paths that are not displayed on the input screen 38, onto the input screen 38.

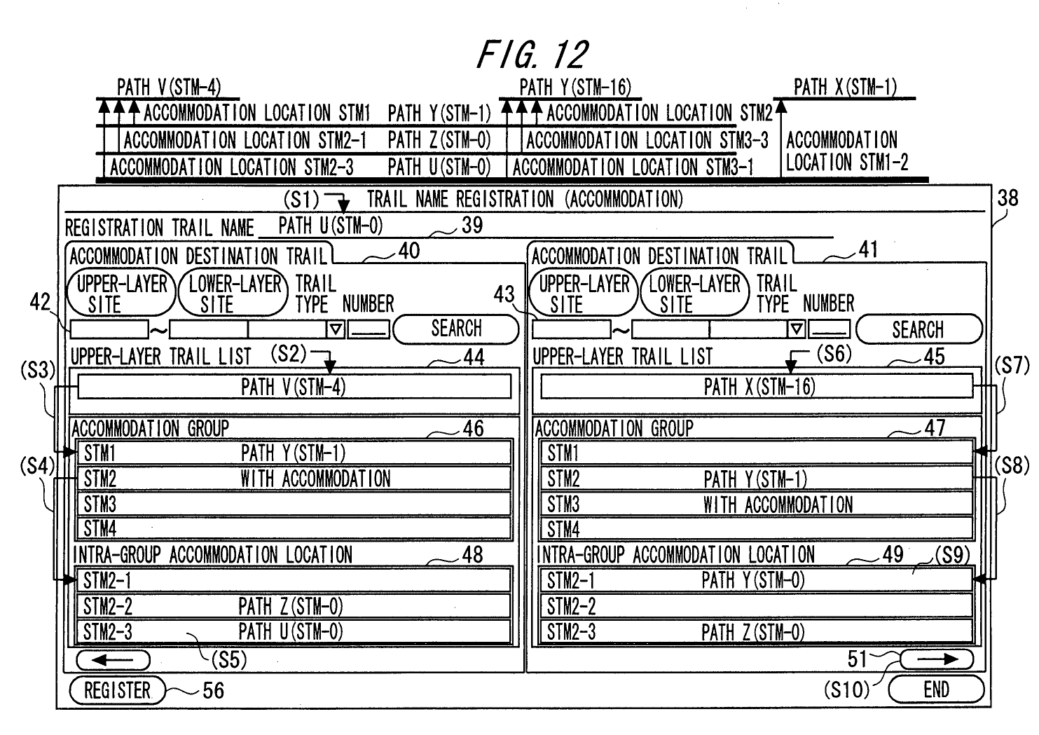

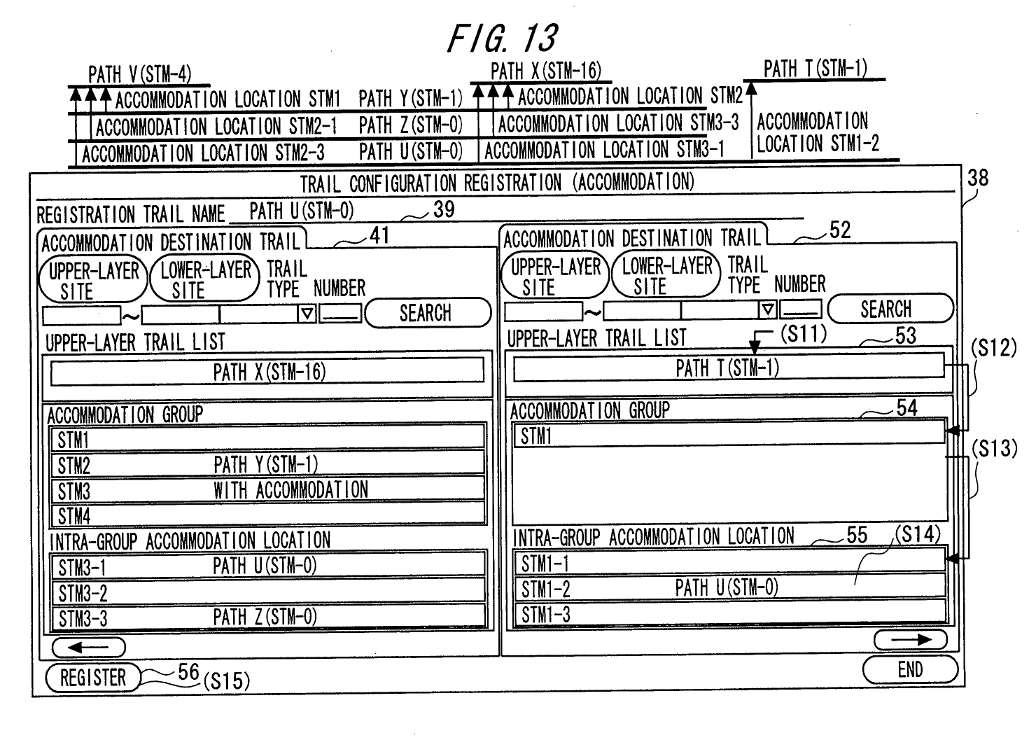

FIGS. 12 and 13 show how to operate the trail configuration input screen 38 for registering a new trail configuration. FIGS. 12 and 13 show the trail configuration input screen 38 in the case of newly registering a path U (STM-0) in the SDH network.

In FIG. 12, when the operator calls the trail configuration input screen 38, the operator first inputs a name of the own trail (path U) to be registered, as a registration name. The inputted name is displayed in the display field 39 [(S1) of FIG. 12].

In this example, the upper-layer trails accommodating the path U are three paths of the path V (STM-4), the path X (STM-16), and the path T (STM-1), which become the accommodation destination trails of the path U. It should be noted that the accommodation order of the path V, path X, and path T for the path U is path V→path X→path T.

In order to extract the above-mentioned upper-layer paths, the operator uses a certain tab (for example, the tab 40) displayed on the input screen 38 to input the search conditions for the upper-layer trails of the path U in the setting fields 42, and presses the search button. Then, a list of the upper-layer trails as the search result displayed on the display area 44 on the tab 40 [(S2) of FIG. 12]. The list includes the records of the paths V, X, and T corresponding to the upper-layer trails.

The operator selects (mouse-clicks) the path V from the list according to the accommodation order. Then, the record of the path U becomes the only displayed content of the display area 44, and a list of the accommodation groups of the path U is displayed as the accommodation states of the path U [(S3) of FIG. 12]. The list includes records indicating four accommodation groups accommodated in the path U.

Here, the path U is scheduled to accommodate the accommodation group STM2 of the path V in the accommodation location STM2-3. Accordingly, the operator selects the accommodation group STM2 from the list of the display area 46 through mouse-clicking or the like. It should be noted that the record of the accommodation group STM2 in the display area 46 includes “with accommodation” indicating that the path D is included.

Upon selection of the accommodation group STM2, the display area 48 displays a list indicating the accommodation states within the accommodation group STM2. This list is composed of records each indicating the accommodation location of the STM-0 and a name of the path of STM-0 accommodated at the location. At this time, the record of the accommodation location in a vacant state is displayed in such a manner as to indicate the vacant state. For example, the display is performed in such a manner that the path name is not displayed [(S4) of FIG. 12]. Here, assuming that the accommodation location of the path U (own trail) to be registered is the STM2-3, the record with respect to the accommodation location of the STM2-3 is displayed in such a manner as to indicate a state (vacant state) for accommodating no path.

Upon confirmation that the location STM2-3 scheduled for accommodation is in a vacant state, the operator designates the accommodation location of the own trail (path U) [(S5) of FIG. 12]. The designation can be executed, for example, by adding the name of the path U to a predetermined record in the display area 48.

Then, the operator determines the accommodation location of the path X. The operator uses the tab 41 to display the list of the upper-layer trails in the display area 45 through operation similar to that of (S2) described above [(S6) of FIG. 12]. In this case, the operator specifies the path X.

It should be noted that when the tab 40 is used to designate the search conditions and the search button is pressed, the tab 40 may have only the record of the path U displayed in the display area 44, and the tab 41 may have only the record of the path X displayed. Accordingly, the operator does not need to repeat the same operation for each tab.

Upon designation of the path X, in the display area 47, the displayed contents in the display area 45 become only the record of the path X, and the display area 47 displays the list of the accommodation groups of the path X as the accommodation states of the path X [(S7) of FIG. 12].

Here, the path U is scheduled to accommodate the accommodation group STM3 of the path X in the accommodation location STM3-1. Accordingly, the operator selects the accommodation group STM3 from the list of the display area 47 through mouse-clicking or the like.

Upon selection of the accommodation group STM3, the display area 49 displays a list indicating the accommodation states within the accommodation group STM3 [(S8) of FIG. 12]. Here, the accommodation location of the path U (own trail) is the STM3-1, and the record with respect thereto is displayed in such a manner as to indicate the state (vacant state) for accommodating no path. Upon confirmation that the location STM3-1 scheduled for accommodation is in the vacant state, the operator specifies the accommodation location of the path U [(S9) of FIG. 12].

Then, the operator needs to set the path U in terms of the upper-layer trail (path T), and therefore, operates the rightward arrow button 51 to call another tab onto the input screen 38. Then, the state of input screen 38 transits to a state shown in FIG. 13. In other words, the tab 40 for the path V disappears from the screen, and the tab 41 shifts to the display position of the tab 40. Then, another tab 52 is displayed in the previous location of the tab 41. The tab 52 has the same structure as each of the tabs 40 and 41.

The operator uses the tab 52 to perform the same operation as that with respect to each of the tabs 40 and 41, and displays the list of the upper-layer trails of the path U in a display area 53 for the upper-layer trail list on the tab 52 [(S11) of FIG. 13]. The operator designates the record of the path T. Upon designation of the path T, the displayed contents in the display area 53 become only the record of the path T, and a display area 54 displays the list of the accommodation groups of the path T as the accommodation states of the path T [(S12) of FIG. 13].

Here, the path T is of STM-1, so that the path T has only one accommodation group “STM1”. Accordingly, the operator selects the accommodation group STM1 through mouse-clicking or the like. Upon selection of the accommodation group STM1, a display area 55 on the tab 52 displays a list indicating the accommodation states within the accommodation group STM1 [(S13) of FIG. 13].

Here, the accommodation location of the path U (own trail) is the STM1-2, and the record with respect thereto is displayed in such a manner as to indicate the state (vacant state) for accommodating no path. Upon confirmation that the location STM1-2 scheduled for accommodation is in the vacant state, the operator specifies the accommodation location of the path U [(S14) of FIG. 13].

As described above, the specification/selection/input ends for registration contents of the path U being the own trail. Then, the operator presses a registration button 56 provided on the input screen 38. Then, the registration contents of the path U set on the tabs 40, 41, and 52 are passed from the Web terminal 10A over to the trail management unit 20A, and registered in the trail management DB 23.

It should be noted that in the above-mentioned example, description is made of operation in which the operator performs the registration processing after the operator previously determines the accommodation location of the own trail in the upper-layer trail. On the other hand, the operator may determine the accommodation destination of the own trail after the operator references the displayed contents in the display areas for the accommodation groups and the intra-group accommodation location on each tab, and grasps the vacant state.

According to the configuration described above, by designating the search conditions when registering the trail configuration, the operator can call upper-layer trail of the own trail onto the operation screen (input screen 38). Then, by designating the called upper-layer trails, it is possible to display the vacant states of the upper-layer trails on the input screen 38. Then, the accommodation locations of the own trail with respect to the upper-layer trails can be defined and registered.

Thus, the unit on the own trail with respect to a plurality of upper-layer trails can be executed at a time. Therefore, unlike the conventional art, the operator does not need to register trail configurations for each NE-OPS. Accordingly, it is possible to alleviate the work loads on the operator and prevent undone registration or double registration. Further, by designating a plurality of upper-layer trails in order, the operator can register the trail configuration without taking the conventional category units into consideration.

<Operation and Processing for Management System>

Next, description will be made of the operation for a network management system and the processing for a management system in the case where an operator performs the operation work for an integration network.

The trail management unit 20 (FIG. 2) uses the above-mentioned trail configuration management table 25, the work-category-unit NE-OPS cooperation table 24, and the category-unit NE-OPS management table 29, and automatically recognizes a category-unit NE-OPS requiring cooperation on a trail management work basis. Hereinafter, description will be made step by step.

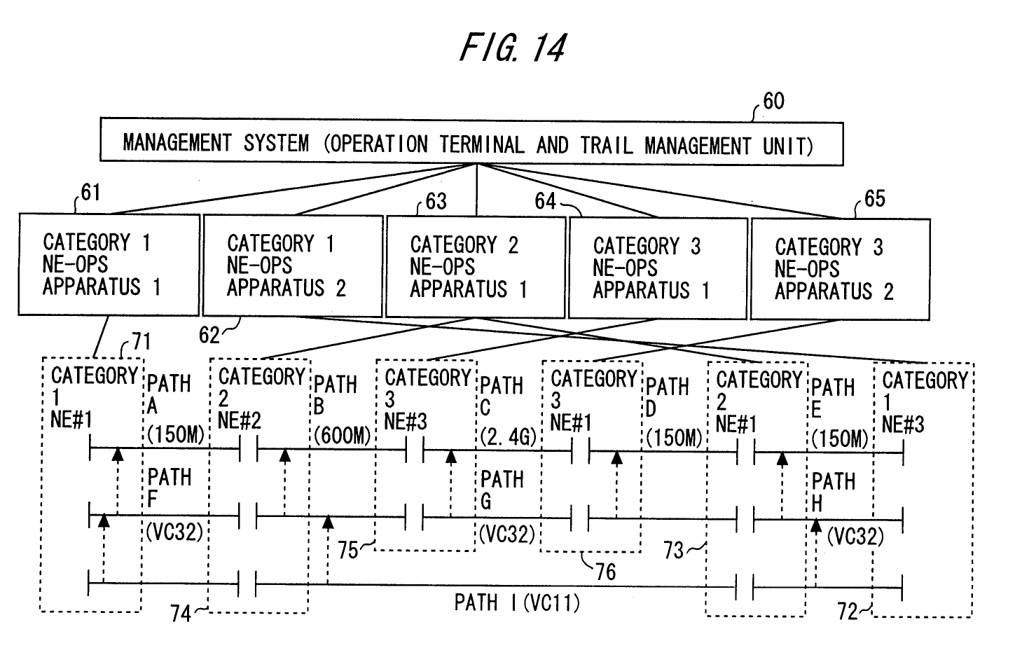

FIG. 14 shows category-unit NE-OPSs, category-unit NEs, and an integration network composed of the NEs. In FIG. 14, the integration network has the following configuration.

A category 1 NE-OPS apparatus 1 (OPS 61) is connected to its subordinate category 1 NE#1 (NE 71). A category 1 NE-OPS apparatus 2 (OPS 62) is connected to its subordinate category 1 NE#3 (NE 72). A category 2 NE-OPS apparatus 1 (OPS 63) is connected to a category 2 NE#1 (NE 73) and a category 2 NE#2 (NE 74) subordinated thereof. A category 3 NE-OPS apparatus 1 (OPS 64) is connected to its subordinate category 3 NE#3 (NE 75). A category 3 NE-OPS apparatus 2 (OPS 65) is connected to its subordinate category 3 NE#1 (NE 76).

Provided in a layer above the OPSs 61 to 65 is a network management system 60 (the Web terminal 10A and the trail management unit 20), and the NE-OPSs 61 to 65 are each connected to the network management system 60. Paths (trails) A to I are set between the NEs as follows.

The path A (150 Mbps) is set between the NE 71 and the NE 74 (between the categories 1 and 2), and the NE 71 and the NE 74 terminate the path A. The path B (600 Mbps) is set between the NE 74 and the NE 75 (between the categories 2 and 3), and the NE 74 and the NE 75 terminate the path B. The path C (2.4 Gbps) is set between the NE 75 and the NE 76 (within the category 3), and the NE 75 and the NE 76 terminate the path C. The path D (150 Mbps) is set between the NE 76 and the NE 73 (between the categories 3 and 2), and the NE 76 and the NE 73 terminate the path D. The path E (150 Mbps) is set between the NE 73 and the NE 72 (between the categories 2 and 1), and the NE 73 and the NE 72 terminate the path E. The path F (VC32) is set between the NE 71 and the NE 74 (between the categories 1 and 2), and the NE 71 and the NE 74 terminate the path F. The path F is accommodated in the path A. The path G (VC32) is set between the NE 73 and the NE 74 via the NEs 75 and 76 (between the categories 2, 3, and 2). The NEs 74 and 73 terminate the path G. The path G is accommodated in the paths B, C, and D. The path H (VC32) is set between the NE 73 and the NE 72 (between the categories 1 and 2), and the NE 73 and the NE 72 terminate the path H. The path H is accommodated in the path E. The path I (VC11) is set between the NE 71 and the NE 72 via the NEs 74 and 73 (between the categories 1, 2, and 1). The NEs 71 and 72 terminate the path I. The path I is accommodated in the paths F, G, and H.

The NEs 71 and 72 belonging to the category 1 terminate networks (lines or paths) in layers of 150M, VC32, and V11, and subject those to their own management subjects. The NE 73 belonging to the category 2 terminates 150M, VC32, and VC11, and subjects those to its own management subject. The NE 74 belonging to the category 2 terminates 150M, 600M, VC11, and VC32, and subjects those to its own management subject. The NE 75 belonging to the category 3 terminates 600M, 2.4G, and VC32, and subjects those to its own management subject. The NE 76 belonging to the category 3 terminates 2.4G, 150M, and VC32, and subjects those to its own management subject. Accordingly, the layer of VC11 is out of the management subjects of the NEs 75 and 76 belonging to category 3. It should be noted that names (150M, VC32, etc.) within parentheses beside path (trail) names shown in FIG. 14 mean trail types.

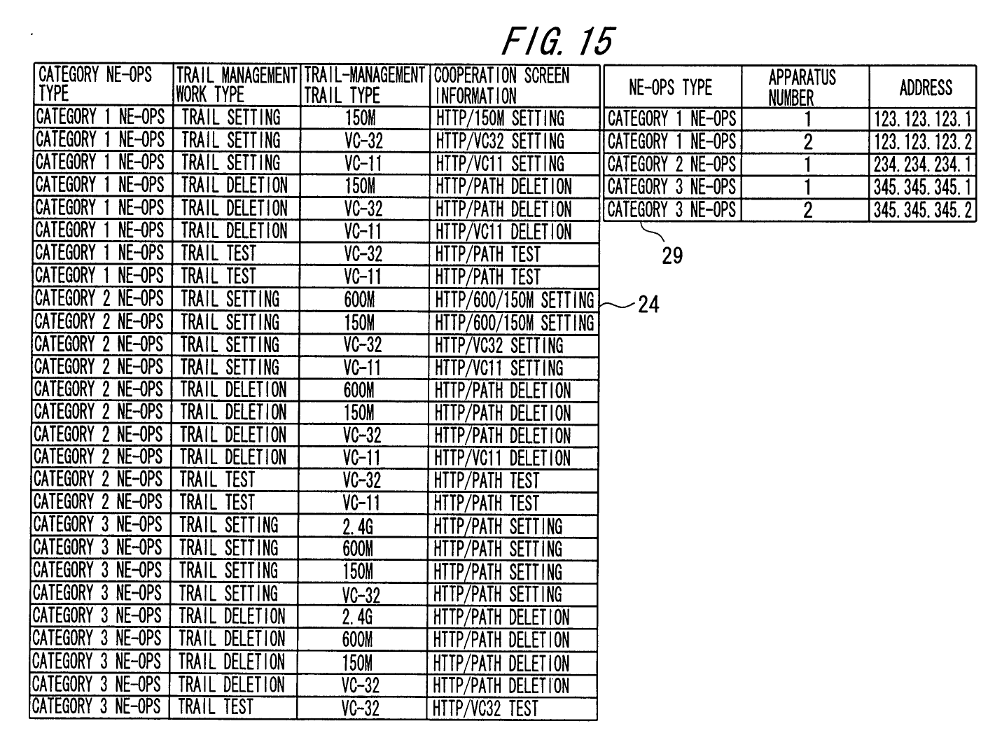

FIG. 15 shows trail-management cooperation NE-OPS information managed by the network management system 60. FIG. 15 shows the work-category-unit NE-OPS cooperation table 24 and the category-unit NE-OPS management table 29 corresponding to the configuration of the integration network shown in FIG. 14. Information on the NE-OPSs stored in those tables 24 and 29 is called “OPS information” as necessary. The OPS information is registered into the tables 24 and 29 in advance before the operation work by the operator using the network management system 60.

Next, description will be made of the operation work using the network management system 60 (operation and processing for the network management system 60). The operator first operates the network management system 60, and designates the category-unit NE-OPSs in layers (in FIG. 14, path A, path B, path C, path D, and path E) through which trails are physically connected to apparatuses (NEs). Such operation will be described by taking the path A and path B as an example.

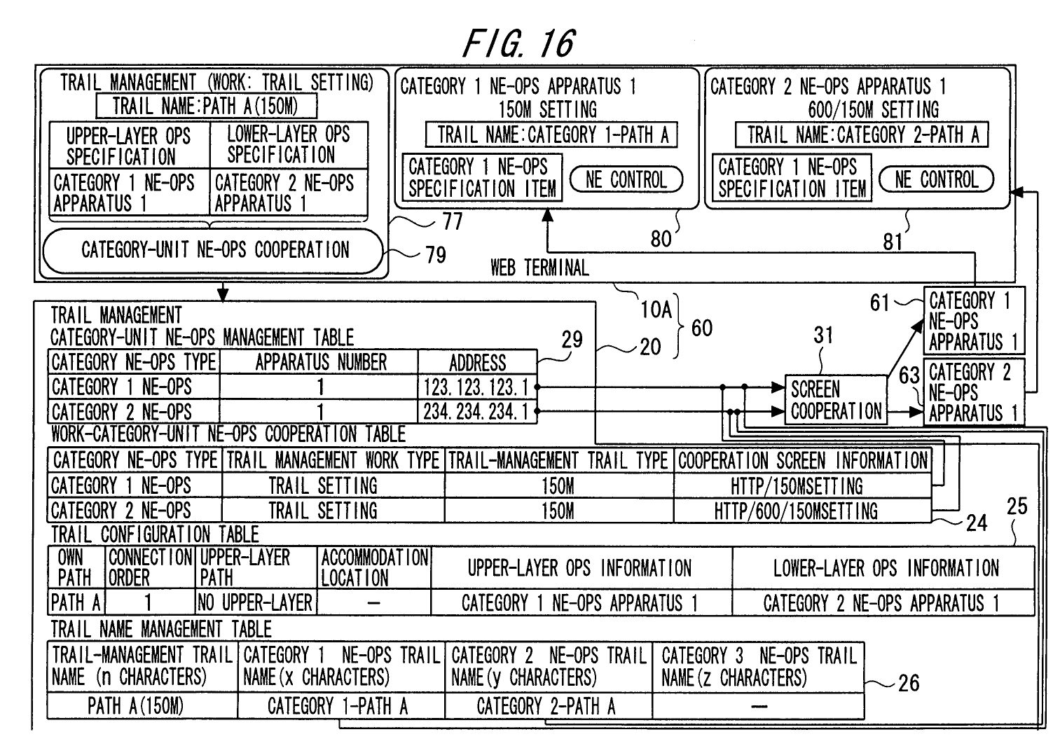

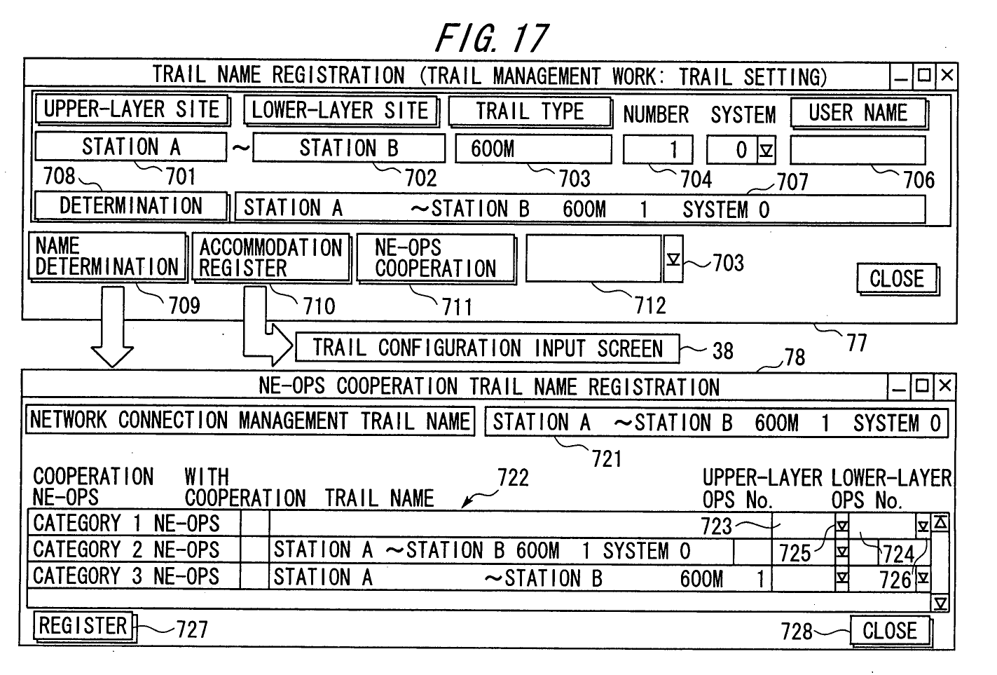

FIG. 16 shows an operational example of the network management system 60 (Web terminal 10A and trail management unit 20) at the time of cooperation, and FIGS. 17 to 20 show display examples of the input screen at the time of cooperation. It should be noted that FIG. 16 shows a cooperation operation regarding the path A (150 Mbps), and FIGS. 17 to 19 show screen input examples regarding the path B (600 Mbps).

In the case of performing work (trail setting) on the path A, the operator uses the management system 60 to register the trail name of the path A and then designates the category-unit NE-OPS to be subjected to cooperation.

The setting of the path A requires cooperation between the category 1 NE-OPS apparatus 1 (OPS 61) and the category 2 NE-OPS apparatus 1 (OPS 63). The operator calls a trail management work screen (management work screen) 77 as shown in FIG. 17 onto the display of the Web terminal 10A.

The management work screen 77 is provided for each trail management work type (e.g., trail setting, trail test, and trail deletion). FIG. 17 shows an example of the management work screen 77 in terms of the trail setting. It should be noted that a common trail management work screen in terms of the trail management work types may be provided to allow the operator to designate a trail management work type on the common trail management work screen.

The management work screen 77 includes a function as the above-mentioned trail name registration screen 37 (see FIG. 7A). In other words, the management work screen 77 includes a plurality of input fields 701 to 706 for inputting an upper-layer site, a lower-layer site, a trail type, a number, a system, and a user name as single-unit names for creating a trail name. The operator inputs the upper-layer site, the lower-layer site, the trail type, the number, and the system as essential input items, and presses a determination button 708.

Then, the trail name as the trail-management trail name is created by the method described with reference to FIG. 7, and displayed in the corresponding display field 707. Here, the operator presses a name determination button 709 to display the NE-OPS trail name (category-unit NE-OPS trail name) registration screen 78.

The NE-OPS trail name registration screen 78 (name registration screen 78) includes a trail-management trail name (network-connection-management trail name) display field 721, and the trail-management trail name determined on the management screen 77 is displayed in the display field 721.

Further, the name registration screen 78 includes a display area 722 for inputting and displaying presence/absence of cooperation on the basis of a category-unit NE-OPS (per category-unit NE-OPS) and a list of category-unit NE-OPS trail names. The presence/absence of cooperation is automatically inputted into the display area 722 by extracting a corresponding category-unit NE-OPS type (category related to the own trail) from the cooperation table 24 using, as keys, a work type (designated based on the type of the management work screen 77) and a trail type of a path to be set. On the other hand, the category-unit NE-OPS trail name is created by the method described with reference to FIG. 7. The category-unit NE-OPS trail name is related to the category-unit NE-OPS type extracted from the cooperation table 24, and is automatically inputted into the display area 722. The extraction of the category-basis NE-OPS type (judgment of the presence/absence of cooperation) and the creation of the trail name are performed, for example, by the trail management function unit 21.

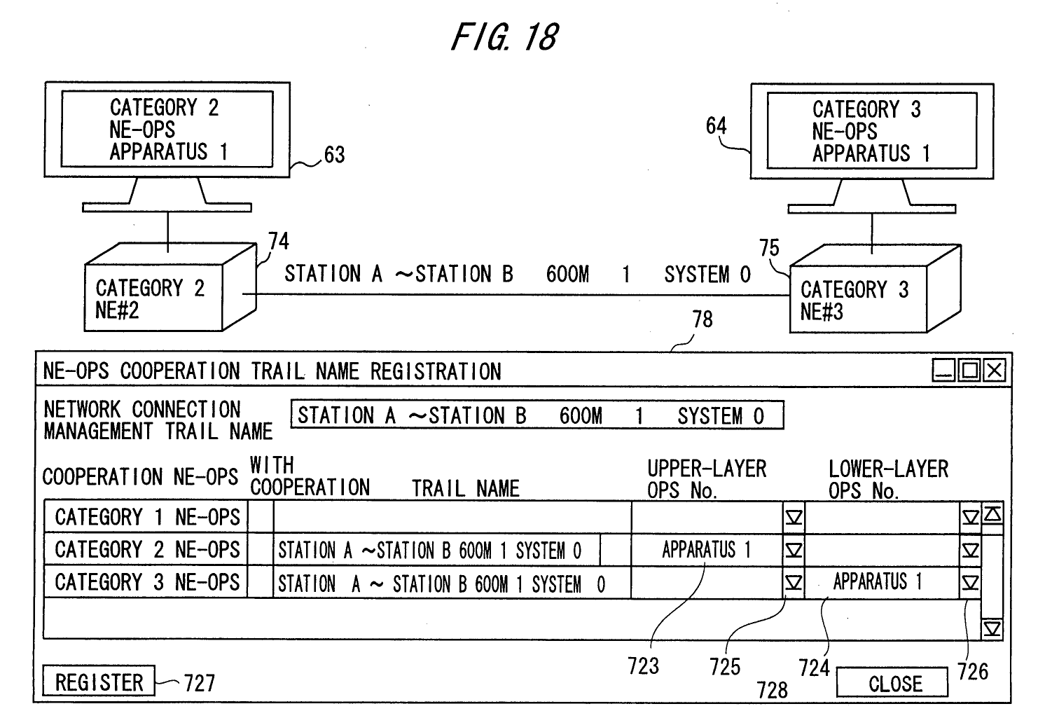

The display area 722 further includes input fields 723 and 724 for respectively inputting identification information for an NE-OPS in an upper-layer (upstream side) for accommodating the path to be set (upper-layer OPS No.) and identification information for an NE-OPS in an lower-layer (downstream side) (lower-layer OPS No.) The input fields 723 and 724 are provided for each category-unit NE-OPS. Provided in the vicinity of the input fields 723 and 724 are display buttons 725 and 726, respectively, for displaying an NE-OPS candidate lists. When one of the list display buttons 725 and 726 is pressed, a pull-down menu (not shown) is displayed for each indicating one or more pieces of the NE-OPS identification information (numbers) corresponding to the category-unit NE-OPS type. The NE-OPS candidates displayed in the pull-down menu are determined/displayed based on the stored contents of the category-unit NE-OPS table 29. The operator can select an NE-OPS related to the path to be set from among the NE-OPS candidates displayed in the pull-down menu (see FIG. 18). FIG. 18 shows a state where the category 2 NE-OPS apparatus 1 (OPS 63) and the category 3 NE-OPS apparatus 1 (OPS 64) are selected as the upper-layer OPS and lower-layer OPS related to the path B, respectively.

The name registration screen 78 further includes a registration button 727 and a “Close” button 728. The “Close” button 728 is used for closing the name registration screen 78 and functions as a cancel button. On the other hand, when the registration button 727 is pressed, the displayed contents of the name registration screen 78 are registered respectively into the trail configuration management table 25 (FIG. 4) and the trail name management table 26 (FIG. 6). In other words, the record related to the path to be set is registered in the trail configuration management table 25, and the trail-management trail name and the category-unit NE-OPS trail name are registered in the trail name management table 26. The registration processing are performed, for example, by the trail management function unit 21.

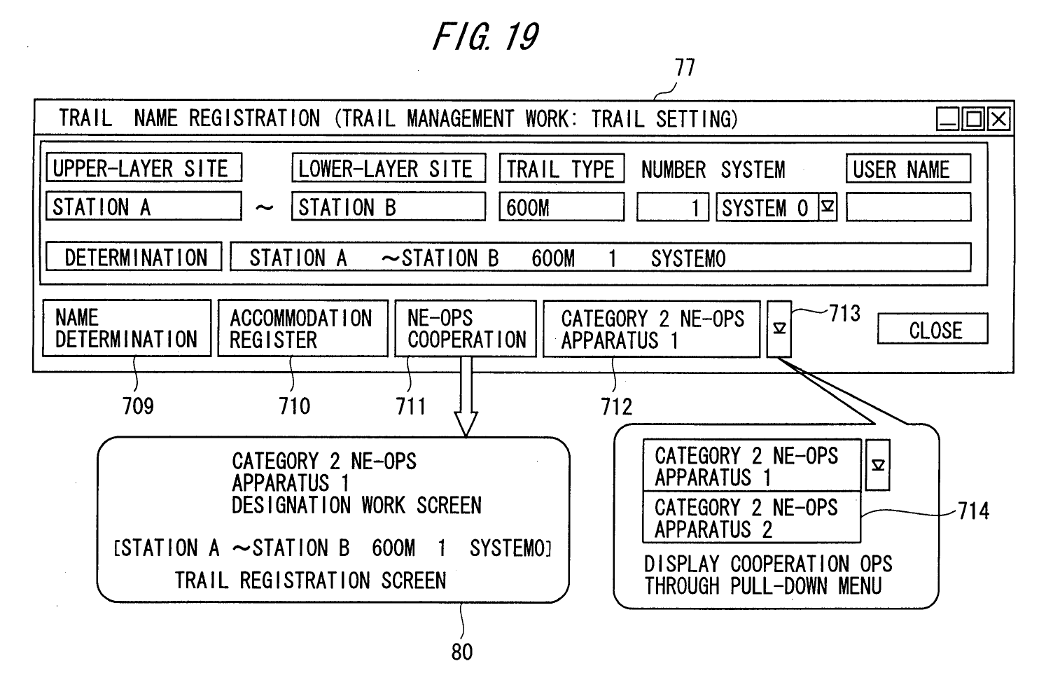

When the registration button 727 on the name registration screen 78 is pressed, the name registration screen 78 is closed, and the management work screen 77 is displayed again. The operator designates the NE-OPS to be subjected to cooperation with respect to the path to be set. The management work screen 77 includes an NE-OPS designation field 712. A display button 713 for displaying a pull-down menu is provided in vicinity of the designation field 712. When the display button 713 is pressed, a pull-down menu 714 is displayed for showing an upper-layer OPS and a lower-layer OPS registered about the path of a setting target, as the NE-OPS candidate to be set (see FIG. 19). The operator can designate the NE-OPS by selecting one NE-OPS from the pull-down menu 714.

When an “NE-OPS cooperation” button (cooperation button) 711 provided to the management work screen 77 is pressed at a state that an NE-OPS designated in the designation field 712, activation processing is performed for the operation screen (path setting screen) of the corresponding NE-OPS. The activation processing will be described with reference to FIG. 16.

When the cooperation button 711 on the management work screen 77 is pressed, in the trail management unit 20, the cooperation function unit 22 (cooperation function unit corresponding to the category 2) corresponding to the designated NE-OPS starts and reads out, as an address of the designated NE-OPS, an address corresponding to the category-unit NE-OPS type and identification information (number) of the designated NE-OPS from the management table 29. Subsequently, the cooperation function unit 22 reads out from the cooperation table 24 the cooperation screen information, the trail management work type (designated based on the type on the management work screen), and the trail type of the path to be set, each corresponding to the NE-OPS type of the designated NE-OPS. The cooperation function unit 22 further reads out from the trail name management table 26 the category-unit NE-OPS trail name corresponding to the designated NE-OPS. Then, the cooperation function unit 22 provides the screen cooperation function unit 31 of the Web terminal 10A with, as screen activation information, HTML information including the address of the NE-OPS, cooperation screen information (URL), and the category-unit NE-OPS trail name.

The screen cooperation function unit 31 interprets the screen activation information, and provides the NE-OPS (OPS 61 in the example shown in FIG. 16) located at the address included therein with an instruction including the cooperation screen information and the category-unit NE-OPS trail name.

Then, the NM management function 11 of the OPS 61 reads out information on the operation screen (setting screen for the path A) of the NE-OPS corresponding to the cooperation screen information from, for example, the NM management DB 13, performs an editing processing for displaying the category-unit NE-OPS trail name on the setting screen, and sends the resultant to the Web terminal 10A.

Based on the information obtained from the OPS 61, the Web terminal 10A displays a path A setting screen 80 for the OPS 61 on the display. Displayed on the setting screen 80 is the corresponding category-unit NE-OPS trail name. In other words, the setting screen 80 with the determined trail name is displayed.

Accordingly, it is possible to eliminate time and labor for inputting the trail name from the operator. Further, an input error for the trail name can be prevented. Further, the trail name is created by use of attributes (upper-layer site, lower-layer site, trail type, number, etc.) of the trail, thereby making it possible to eliminate time and labor for inputting the trail configuration.

It should be noted that in the above-mentioned example, the Web terminal 10A sends the trail name to the NE-OPS, and the NE-OPS performs the editing processing for displaying the trail name on the operation screen. On the other hand, the Web terminal 10A may perform the above-mentioned editing processing without sending the trail name.

Further, when the operator designates the lower-layer OPS and presses a cooperation button 79 on the management screen 77, the above-mentioned activation processing is performed on the lower-layer OPS, and a operation screen (path setting screen) 81 of the lower-layer OPS is activated on the display of the Web terminal 10A.

The operator inputs necessary information to the setting screens 80 and 81 and presses an NE control button. Then, the contents (designation items related to the settings) inputted to the setting screen 80 are sent to the OPS 61, and the contents inputted to the setting screen 81 are sent to the OPS 63. It should be noted that the number of passing cells, a bandwidth, an alarm, and a performance monitor are exemplified as the designation items, and parameters therefor are set.

The OPS 61 and 63 control their subordinate NEs (NEs 71 and 74) based on the received designation items, respectively, and the path A is set (registered). The operator can thus perform the setting work for the path A.

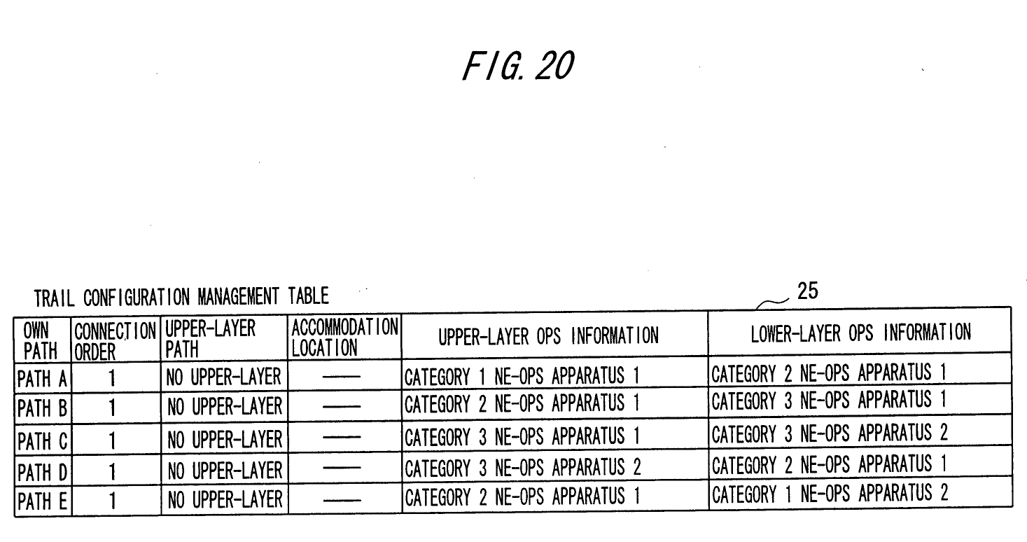

The operator can use the operation similar to the above to activate the operation screen (path setting screen) of the NE-OPS with respect to the trails (path B, path C, path D, and path E shown in FIG. 14) in another layer subjected to the physical connection. FIG. 20 shows the trail configuration management table 25 in the case where the above-mentioned operation is used to register the paths A to E.

Next, description will be made of the settings of the trails accommodated in the upper-layer trail (paths having an upper-layer path; path F, path G, and path H of FIG. 14). The path accommodated in the upper-layer path has its trail configuration registered to thereby allow recognition of the OPS cooperation information (upper-layer OPS and lower-layer OPS) related to the upper-layer path. Therefore, with regard to the lower-layer trail (subordinate trail), only the trail configuration is registered, and the category-unit NE-OPS to be a cooperation destination is automatically recognized, thereby making it possible to activate the corresponding operation screen.

Description will be made by taking the setting of the path G as an example. In the case of registering the configuration of the path G, the operator operates the Web terminal 10A to call the trail management screen 77 as shown in FIG. 17, and determines the management trail name of the path G. After that, the operator presses an accommodation registration button 710 provided to the trail management screen 77.

Then, the trail configuration input screen 38 as shown in FIG. 10 is displayed on the display. At this time, the trail-management trail name of the path G determined in the management screen 77 is displayed in the display field 39. Subsequently, the operator can search for the upper-layer paths (accommodation destination trail) of the path G. In other words, when the operator inputs the search conditions (upper-layer site, lower-layer site, trail type, number, etc.) of the upper-layer trail accommodating the path G and presses the search button, the upper-layer trails having the name that matches the search conditions are extracted from the trail configuration management table 25 and displayed in the display field 44. After that, the same method as described with reference to FIGS. 11 to 13 is used to specify the upper-layer trail of the path G from the display field 44 and determine the accommodation location of the path G with respect to the upper-layer trail.

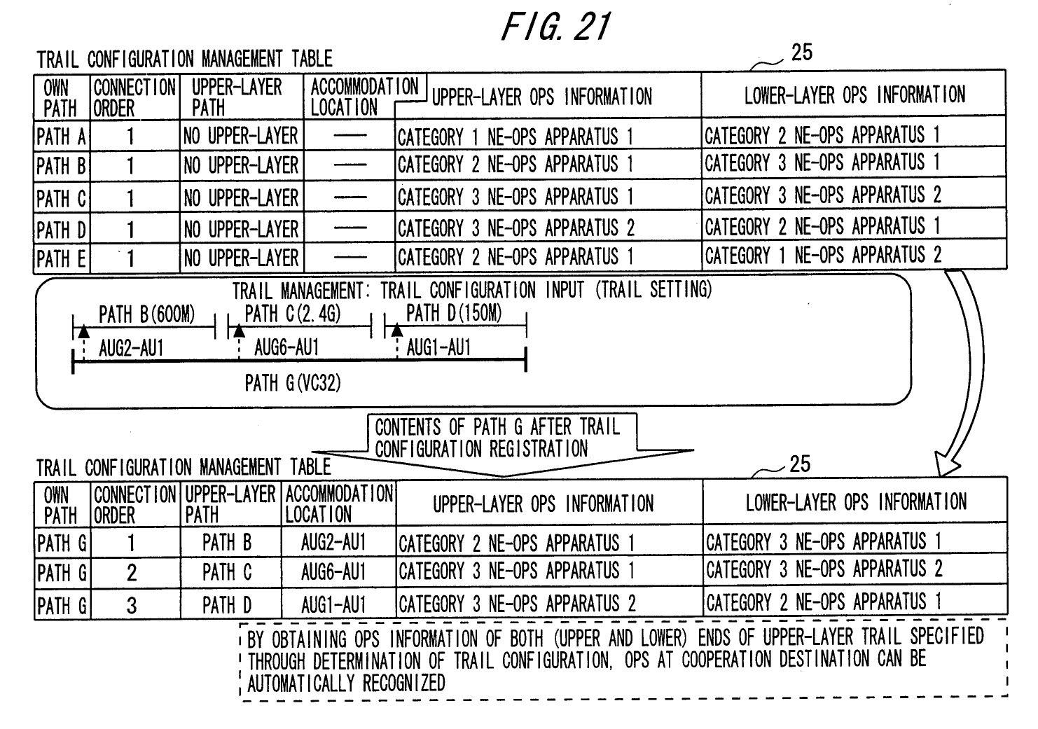

With regard to the upper-layer trail designated at this time, the information (upper-layer OPS and lower-layer OPS) on the cooperation destination OPS is already registered in the trail configuration management table 25. On the other hand, in the relationship between the path G and the designated upper-layer trail, the upper-layer OPS and the lower-layer OPS are the same. Accordingly, the information on the upper-layer and lower-layer OPSs of the designated upper-layer trail is inputted as information on the upper-layer and lower-layer OPSs of the own trail (own path; path G herein), thereby making it possible to determine the cooperation destination of the own trail. Therefore, if the path B, for example, is designated as the upper-layer path of the path G and the accommodation location of the path G in the path B is designated, the trail management unit 20 (for example, trail management function unit 21) automatically creates the record of the path G related to the path B, and registers the record into the trail configuration management table 25. The operator can use the same method to register the record of the path G related to the path C into the trail configuration management table 25. FIG. 21 shows how the configuration (cooperation information) of the path G is registered (how a trail having upper-layer accommodation is automatically recognized).

After that, the operator returns to the management screen 77 to press the name determination button 709 with the trail-management trail name of the path G displayed in the display field 707. Then, the registration screen 78 is displayed, and in the registration screen 78, the category-unit NE-OPS trail name of the path G is automatically created. Automatically displayed in the display fields 723 and 724 at this time is information on the upper-layer and lower-layer OPSs created by using the information on the upper-layer and lower-layer OPSs registered in the trail configuration management table 25. Then, if the operator presses the registration button 727 to register the trail name of the path G into the trail name management table 26, the trail management unit 20 comes into a state that allows creation of the screen activation information on the path G.

Therefore, the operator returns to the management screen 77 to press the cooperation button 711 while specifying the NE-OPS at the cooperation destination, thereby making it possible to activate the operation screen of the NE-OPS related to the designated path G. Accordingly, the operator can set the lower-layer path in a layer lower than a physical layer.

Thus, with regard to the trail accommodated in the trail in a physical layer, it is unnecessary for the operator to designate the upper-layer and lower-layer OPSs for the registration of the trail configuration. Then, the operator returns to the management screen 77 to press the cooperation button 711 while designating the NE-OPS at the cooperation destination, thereby making it possible to activate the operation screen of the NE-OPS related to the designated path G. Accordingly, the operator can set the lower-layer path in a layer lower than a physical layer.

It should be noted that in the above-mentioned example, after the accommodation registration using the screen 38, the screen 78 is activated through the screen 77. Alternatively, after the completion of the accommodation registration, the screen 78 may be automatically activated. Further, in the above-mentioned example, the operator calls the screen 78 to input an instruction to register the category-unit NE-OPS trail name that has been automatically created, thereby registering the trail name into the trail name management table 26. Alternatively, at the time of the completion of the accommodation registration, an internal processing of the trail management unit 20 may cause the category-unit NE-OPS trail name to be automatically created and to be registered into the trail name management table 26.

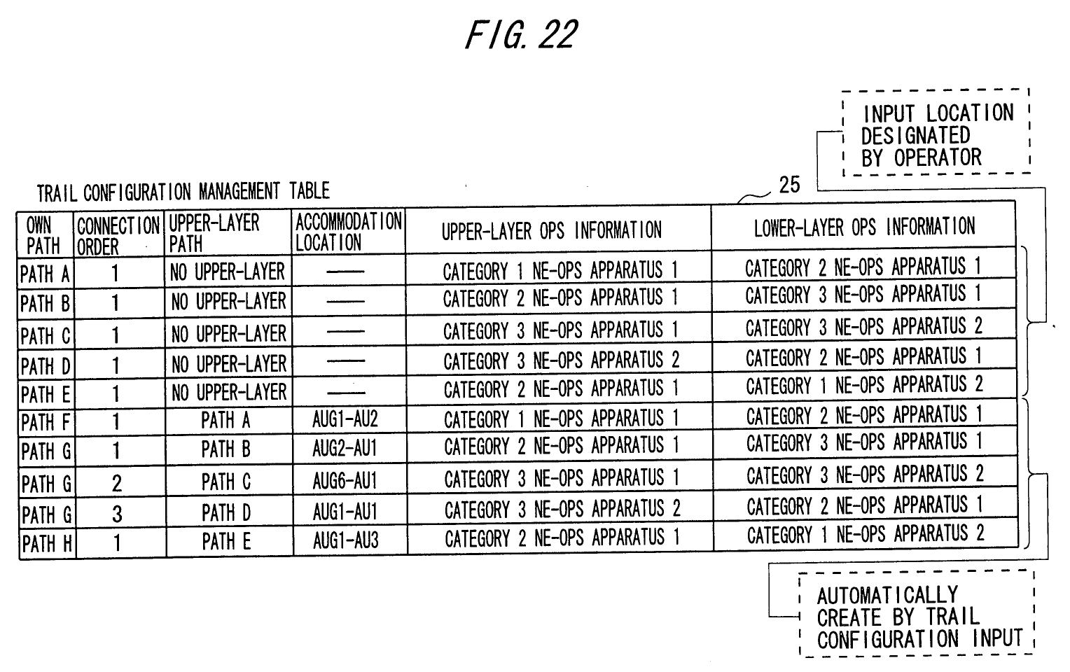

After that, with regard to the other trails (in FIG. 14, path F and path H) in a layer directly under the layer for physical connection, the operator performs the same operation as the operation related to the path G, thereby making it possible to link the activation of the setting screens of the paths F and H. FIG. 22 shows contents of the trail configuration management table 25 into which a new record is registered for a trail in a layer directly under the layer for physical connection.

It should be noted that in the above-mentioned example, the accommodation registration for the path to be set is performed in order from the upstream side, so that the registration order is automatically registered in the management table 25 as the connection order of paths. Alternatively, the operator may input the connection order.

Next, description will be made of operation for setting a trail in a further lower layer (the path I in FIG. 14). With regard to the setting of the path I, the operator may perform the operation similar to that described for the path G.

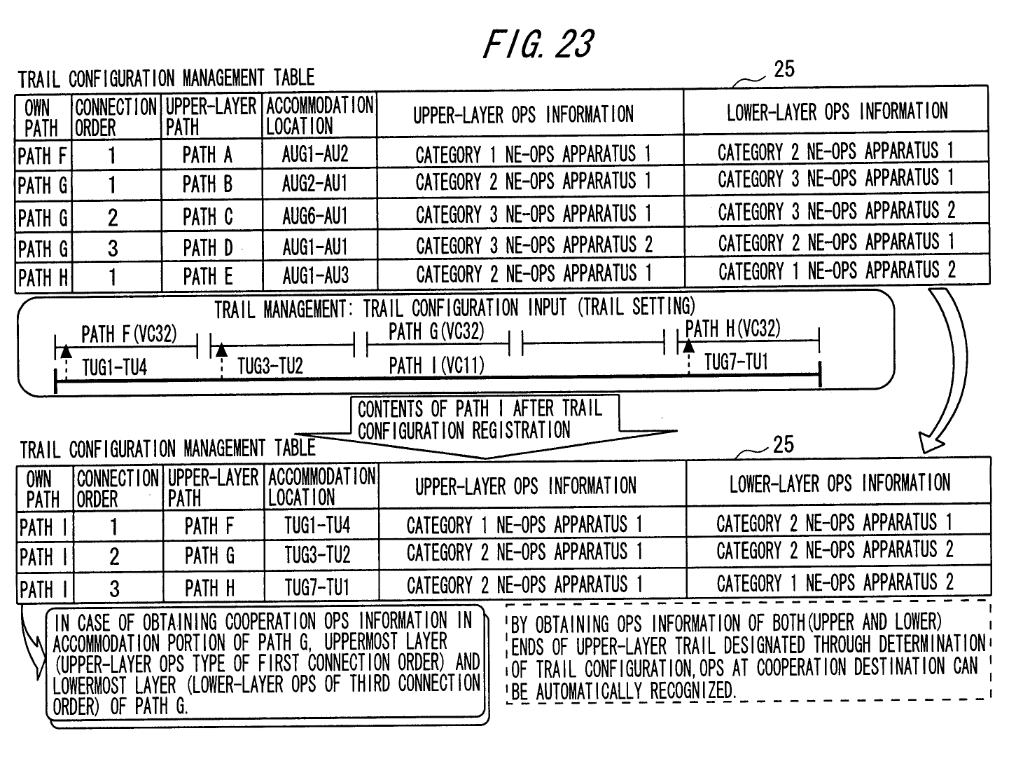

FIG. 23 shows how the configuration (cooperation information or cooperation OPS information) of the path I is registered. As shown in FIG. 23, when the record of the path I is created, automatically obtained is information on the upper-layer and lower-layer OPSs of the paths (path F, path G, and path H) in a layer directly above the path I which accommodate the path I, that is, endpoint information. In the case of obtaining the cooperation OPS information on the accommodation portion of the path G, the uppermost-layer OPS (upper-layer OPS type of first connection order) and the lowermost-layer OPS (lower-layer OPS of third connection order) of the path G are obtained. In other words, in the case where the upper-layer trail of the path to be set is accommodated in a plurality of trails, it is necessary to obtain the uppermost layer and lowermost layer OPS types of the upper-layer trail. Here, the OPS information is already stored in the trail configuration management table 25 in a connection order and in an order of the upper layer and lower layer of the connected path in terms of the upper-layer trail. Thus, the OPS type on an upper-layer side having a minimum value for the connection order is obtained as the uppermost-layer OPS, and the OPS type on a lower-layer side having a maximum value for the connection order is obtained as the lowermost-layer OPS.

Accordingly, the category-unit NE-OPS at the cooperation destination is recognized, leading to a state where element information of the screen activation information related to the path I is registered in each table within the trail management unit 20. In other words, the same operation as the operation shown in FIG. 16 allows creation of the screen activation information of the NE-OPS related to the settings of the path I.

Accordingly, the operator calls the trail management work screen 77, sets the trail name of the path I through the screen 77, and registers the trail configuration of the path I through the screen 38. Then, without consideration of the category-unit NE-OPS connected to the management system 60, the related category-unit NE-OPS is automatically registered, and the operation screen of the NE-OPS can be activated on the display of the Web terminal 10A as necessary.

Normally, in the case where NEs are introduced, installation of NEs and physical connection (optical fiber etc.) are executed immediately after the installation of NEs, and changes in the physical connection do not occur in the normal operation. As daily routine work occurring in the normal operation, logical path setting work (Soft Strap) within the NEs occurs. As described above, in terms of physical connection, the operator designates the cooperation OPS, but such work does not often occur in the daily operation. Thus, requirements are assumed to be satisfied in terms of operation.

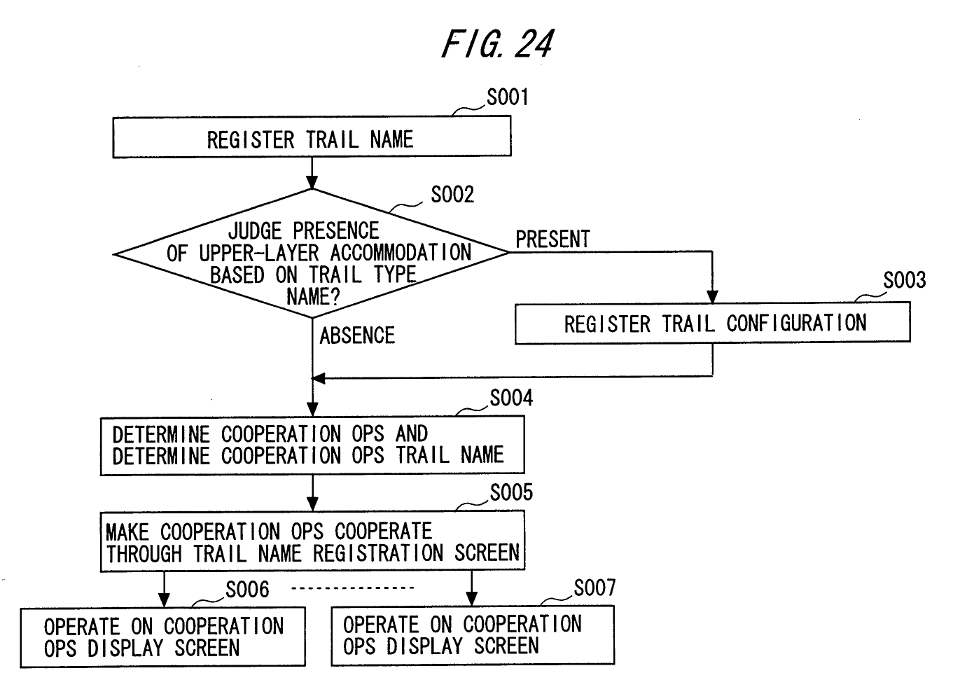

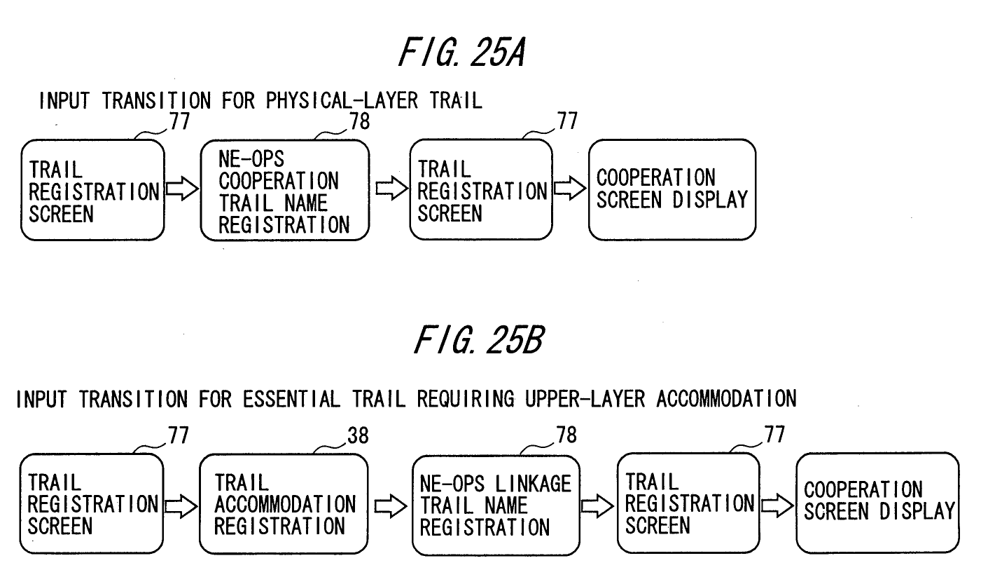

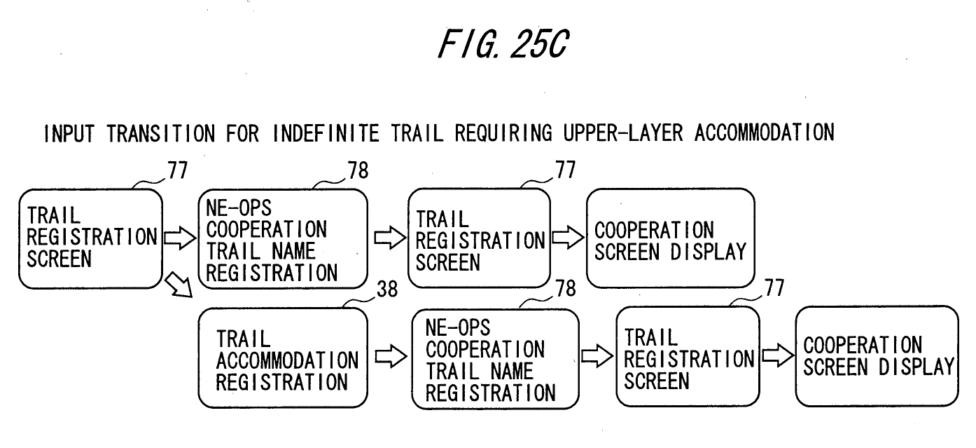

FIG. 24 shows a operation flow of the management system 60, and FIG. 25 shows a screen input flow upon operation of the management system 60, where FIG. 25A shows transition of the input screen related to a physical-layer trail, FIG. 25B shows input transition for a trail requiring upper-layer accommodation, and FIG. 25C shows input transition for a trail optionally requiring upper-layer accommodation.

In the case of setting a trail on a physical layer, the operator first calls the management work screen 77, and registers the trail-management trail name of the trail to be set (S001). Then, the operator judges the presence/absence of the upper-layer accommodation trail based on the trail type name (S002). At this time, since there is no upper-layer accommodation trail (S002; absent), the operator calls the name registration screen 78, and determines the category-unit NE-OPS trail name while determining the cooperation OPSs (upper-layer and lower-layer OPSs) (S004). Then, the operator activates each of the operation screens of the cooperation OPSs from the management work screen 77 (S005), and uses the activated operation screens to input instructions with respect to the NE-OPSs (S006 and 007).

Further, in the case of setting the trail requiring upper-layer accommodation (trail that needs to be accommodated in a predetermined trail), the operator first calls the management work screen 77, and register the trail-management trail name (S001). At this time, since there is an upper-layer accommodation trail, the operator advances the processing to step S003 to call the trail configuration input screen (accommodation registration screen) 38 and perform accommodation registration. After that, the same unit as in the case of the physical-layer trail are performed. Also, the operator performs one of the above-mentioned two operations with regard to the trail optionally requiring upper-layer accommodation.

### Effects of the Embodiment

The management system is located in the upper layer of the NE-OPSs that manage networks on a category unit, and manages trails in the entire network.

The management system uses the trail management unit 20 to manage trail configurations in the entire network. Also, the management system manages trail names. With regard to the names, the management system additionally manages (including name creation and editing) the name (category-unit NE-OPS trail name) for each category-unit NE-OPS related to the own path.

Further, in the case where the cooperation is effected with respect to the category-unit NE-OPS in the trail management unit 20, the management system uses the information on the NE-OPS managed by the trail management unit 20 to activate and display the operation screen of the NE-OPS previously managed by the NE-OPS directly onto the operation terminal 10. Accordingly, the existing function of the category-unit NE-OPS can be directly used. On the other hand, the trail management unit 20 does not need to execute operation in correspondence with the function of the category-unit NE. Therefore, the management screen and internal processing in correspondence with categories do not need to be provided as the function of integrating networks.

Further, according to the management system, the management work is performed after the trail configuration is first determined in the trail management unit 20 (the location of the path in the entire network is determined). Thus, it is possible to avoid inconsistency in management work (inconsistent registration etc.). Also, as evaluation of the cooperation function, as long as it is confirmed that the operation screens of the category-unit NE-OPSs are displayed in cooperation, the function of the NE-OPS undergoes no correction in terms of the following unit. Therefore, an evaluation period can be minimized.

Further, according to the management system, the trail management unit 20 allows the management of the trail configurations in the entire networks and the trail end point information. Thus, in the trail search, the search with a trail name as a key becomes possible regardless of the category-unit contents. Also, based on the trail name of a trail from which a fault has been detected in the category-unit NE-OPS, a search can be executed for the scale of fault over the entire network and an influenced range.

Further, according to the management system, even in the case of adding the NE-OPS of a new category, the NEs of the new category and the management functions of the NEs are all implemented by the NE-OPSs. Therefore, the trail management unit 20 may only have to add the management functions for the trail names and the contents related to the trail configurations, and if the operation screen of the NE-OPS of the new category can be activated through cooperation with the NE-OPS with the trail name and trail configuration under management as parameters, the cooperation with the new category NE-OPS is regarded to have been implemented.

According to the management system in accordance with the embodiment, the cooperation between OPSs is executed while maintaining coexistence between the trail management function and the NM function of the NE-OPS. Therefore, the scale of the trail management can be reduced compared to the conventional integration network.

Further, the coexistence is maintained between the trail management function and the NM function of the NE-OPS, so that system expansion can be executed without removing the NM function of the NE-OPS.

Further, in the trail management, with respect to the logical trail accommodated in the physical layer trail, the trail configuration can be inputted regardless of the category-unit NE-OPS Accordingly, the operator no longer needs to be sensitive to a management scheme for the conventional category-unit NE-OPS, thereby alleviating the operation loads.

Further, in the trail configuration input (accommodation registration), the accommodation state of another trail can be grasped, thereby making it possible to avoid problems including the input error in the joint portion between categories and overlapping accommodation registration.

Further, since the trail configuration is managed without being sensitive to categories, if the trail configuration is search-edited in the trail management, a search can be facilitated for an influence at the time of fault or an influenced range at the time of work.

Further, in the trail management and between works of the category NE-OPSs, only the screens requiring cooperation may be activated. Accordingly, it is also possible to suppress initial cost at the time of system introduction by cooperation of only the categories requiring integration and the like.

### INDUSTRIAL APPLICABILITY

In the integration network formed by integrating a plurality of networks belonging to different categories, the network management system can be utilized for controlling the NE-OPSs that control/manage NEs belonging to the respective categories.

[Others]

The disclosures of international application PCT/JP2002/12933 filed on Dec. 10, 2002 including the specification, drawings and abstract are incorporated herein by reference.

1. A network management system, comprising:
a management unit managing trail configuration information, trail name information, and work-related information related to trail management work as trail-related information related to trails that compose an integration network that is formed by integrating a plurality of networks belonging to different categories, and is provided with at least one network management apparatus in each category; and
a calling unit calling a operation screen of the management apparatus that serves to execute the trail management work managed in a management apparatus side based on the trail-related information.

2. The network management system according to claim 1, wherein:
the management manages a work management table to register the work-related information including a category type to which the management apparatus belongs, a trail management work type, a trail type, and operation screen information of the management apparatus; and
when the management apparatus to be operated and a category, the management work type, and the trail type thereof corresponding to a trail to be managed are designated, the calling unit provides the designated management apparatus with operation screen information corresponding to the designation registered in the work management table, and displays an operation screen based on the operation screen information obtained from the management apparatus on a display device.

3. The network management system according to claim 2, wherein:
a designation screen is provided for designating the management apparatus to be operated and the category, the management work type, and the trail type thereof corresponding to the trail to be managed; and
the designation screen displays identification information of all management apparatuses to be operated which are related to the management work type of the trail.

4. The network management system according to claim 2, wherein the management unit is provided in each category and includes a cooperation function unit reading out the corresponding operation screen information from the work management table and providing the operation screen information to the calling unit in the case where the category corresponding to the management unit itself is designated.

5. The network management system according to claim 1, further comprising registration screen providing unit for providing a registration screen for registering the trail configuration information and the trail name information, wherein:
the management unit manages a trail configuration management table into which the trail configuration information is registered; and
the trail configuration management table stores one or more records including the trail type regarding a trail, presence/absence of an upper-layer trail accommodating the trail, an accommodation location of the trail in the upper-layer trail in the case where the upper-layer trail is present, and identification information of the management apparatus related to the management work for the given trail, which are obtained through the registration screen.

6. The network management system according to claim 5, wherein in the case where a plurality of upper-layer trails accommodating a trail is present, the trail configuration management table stores the records for respective upper-layer trails of the trail.

7. The network management system according to claim 5, wherein:
the management unit manages a trail name management table into which the trail name information is registered; and
the trail name management table stores, per trail unit, a first trail name for managing the trail obtained through the registration screen and a second trail name set in each category related to the management work for the trail.

8. The network management system according to claim 7, wherein:
the registration screen providing unit provides a first trail name registration screen including an input field of a plurality of name elements that include the trail type of the trail to be registered; and
the management unit includes a first trail name creating unit creating the first trail name based on a stack or combination of the plurality of name elements inputted through the first trail name registration screen, and registering the first trail name into the trail name management table.

9. The network management system according to claim 8, wherein the registration screen providing unit presents a plurality of candidates for at least one name element, and the at least one name element is inputted with designation of one of the presented candidates.

10. The network management system according to claim 8, wherein:
the management unit includes a second trail name creating unit creating a second trail name by editing a first trail name according to an editing pattern prepared in each category; and
the second trail name creating unit creates the second trail name in each category related to the management work for the trail to be registered, and registers the second trail name into the trail name management table.

11. The network management system according to claim 5, wherein:
in the case where the trail to be registered is accommodated in at least one upper-layer trail, the registration screen providing unit provides an accommodation location registration screen for registering the accommodation location of the trail in the upper-layer trail; and
the accommodation location registration screen provides a search environment of the upper-layer trail, and displays accommodation states regarding the detected upper-layer trail.

12. The network management system according to claim 11, wherein in the case where the trail to be registered is accommodated in a plurality of upper-layer trails, the accommodation location registration screen provides a work area for simultaneously registering accommodation locations of the trail in the upper-layer trails.

13. The network management system according to claim 6, wherein in the case where the record of the trail accommodated in an upper-layer trail is registered in the trail configuration management table, the management unit registers the identification information of the management apparatus related to the management work for the given upper-layer trail, which is already registered in the trail configuration management table, as identification information of the management apparatus related to the management work for the trail.
